(19) United States
(12) Patent Application Publication
(10) Pub. No.: US 2010/0037191 A1
(43) Pub. Date: Feb. 11, 2010

(54) Method of generating reliability verification library for electromigration

(75) Inventor: Yoshie Kosuge, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/461,067

(22) Filed: Jul. 30, 2009

(30) Foreign Application Priority Data
Aug. 6, 2008 (JP) 2008-202874

(51) Int. Cl. G06F 17/50

(52) U.S. Cl. 716/5; 716/14; 716/17

(57) ABSTRACT

A cell layout library is generated to store data on a cell. The cell includes multiple metal interconnection elements. The multiple metal interconnection elements include a first metal interconnection element group and a second metal interconnection element group. In the first metal interconnection element group, the metal interconnection elements are provided in a first direction, and an electric current flows, as a one-way electric current, in any one of the first direction and a direction opposite to the first direction. In the second metal interconnection element group, the metal interconnection elements are provided in a second direction, and an electric current flows, as a two-way current, in both of the second direction and a direction opposite to the second direction. By referring to the cell layout library, a net list is generated to associate data on the first and second metal interconnection element groups with corresponding resistance values of the first and second metal interconnection element groups, and corresponding identifiers representing the one-way and two-way electric currents.

### INCORPORATION BY REFERENCE

This application is based upon and claims the benefit of relatedity from Japanese Patent Application No. 2008-202874 which was filed on Aug. 6, 2008, the disclosure of which is incorporated herein in its entirety by reference.

### BACKGROUND OF THE INVENTION

1. Field of the Invention

The present invention relates to a method of generating a library which is used for verifying the reliability of an LSI, and to a program for the method. The present invention relates particularly to a method of generating an electromigration (hereinafter referred to as “EM”) verification library, and to the program for the method.

2. Description of Related Art

In recent years, the EM resistance of each metal interconnection in a cell (a minimum unit constituting a function of a semiconductor device) has become no longer negligible with the advancement of microprocessing, and with the use of a layout of multiple contacts according to DFM (design for manufacturing). For this reason, an EM reliability verification library needs to be prepared also for each metal interconnection in a cell. The EM reliability verification library is used when the reliability of each interconnection is verified. Because a method of calculating a frequency limitation value is different depending on how an electric current flows in a metal interconnection, it is important to judge how the electric current flows in each metal interconnection.

In a case where an electric current flows in a two-way direction, the direction in which electrons travel changes alternately. For this reason, metal atoms hardly move. In this case, the frequency limitation value can be more relaxed in this case than in a case where the electric current flows in a one-way direction (because electrons move in one way, metal atoms are prone to move, which causes a break of a metal interconnection).

A computer is used to verify the reliability of an LSI. The computer calculates frequency limitation values respectively for all the resistance elements in each cell. Subsequently, the computer collects the frequency limitation value of the worst element for each parameter of an input waveform skew and each parameter of an output load capacitance. Here, the input waveform represents voltage amplitude in an input terminal of a cell (in a gate of a transistor). The input waveform skew represents a voltage amplitude duration, that is, a time required to change a voltage from 0V to 1V, for example. With these, the computer generates, as libraries for EM and for hot carriers (hereinafter referred to as HCs), an EM reliability verification library and an HC reliability verification library. The EM reliability verification library and the HC reliability verification library are used when the reliability of a device is verified. Subsequently, by referring to the EM reliability verification library and the HC reliability verification library, the computer generates a reliability verification library including the worst EM value and the worst HC value, and uses the thus-generated reliability verification library when the reliability of an LSI is verified.

FIG. 1 is a flowchart showing the operation of a reliability verifier described in Japanese Patent No. 3722690, as a related method of generating a reliability verification library.

The computer executes a process of generating an EM reliability verification library (step S8), a process of generating an HC reliability verification library (step S18) and a process of generating an EM-HC reliability verification library (steps S20 to S22).

Descriptions will be provided for the process of generating an EM reliability verification library (step S8). Step 8 includes steps S1 to S7, which will be described below.

In the step S1, by referring to a cell layout library in which data on each cell is stored, the computer extracts data on all the resistance elements from the data on each cell. Each cell includes multiple resistance elements as all the resistance elements. Of the multiple resistance elements, resistance elements of a first resistance element group represent resistances of multiple metal interconnection elements. Of the multiple resistance elements, resistance elements of a second resistance element group represent resistances of multiple contact elements.

In the step S2, the computer makes a simulation on the basis of a predetermined first formula and the multiple resistance elements (the resistance values of the multiple metal interconnection elements and the resistance values of the multiple contact elements), and calculates an electric current consumption which is consumed by the cell. At this time, the computer samples, as multiple amounts of electric charge, electric currents (amounts of electric charge) which flow respectively in the multiple resistance elements inside the cell.

In the step S3, the computer chooses, as the worst amount of electric charge, an amount of electric charge which is the worst (the largest in this case) among the multiple amounts of electric charge. Then, the computer generates a worst electric charge amount table in which the worst amount of electric charge is stored. Specifically, in the worst electric charge amount table, stored are a time element (unit: ns) as an input waveform skew, a load capacitance (unit: pF) and the worst amount of electric charge (unit: q) corresponding to the time element and the load capacitance. If the number of time elements is three whereas the number of load capacitances is four, then the number of worst amounts of electric charge is 12 (3×4=12). From the multiple resistance elements, the computer chooses, as the worst resistance element, a resistance element corresponding to the worst amount of electric charge. Then, the computer generates a resistance element name table in which the name of the worst resistance element (the resistance element name) is stored. The worst electric charge amount table and the resistance element name table are used as part of the EM reliability verification library.

In the step 4, the computer checks interpolation precision of the worst electric charge amount table and the resistance element name table. Here, the interpolation precision means a degree of precision of interpolating the worst amount of electric charge corresponding to an input waveform skew and load capacitance not included in the worst electric charge amount table. The interpolation precision needs to be checked for the worst electric charge amount table and the resistance element name table.

In the step 5, as a result of the check, the computer judges whether or not the interpolation precision is unreliable. The acceptability of the interpolation precision is judged on the basis of a difference value between the actual worst amount of electric charge corresponding to an input waveform skew and load capacitance as interpolation targets, and the worst amount of electric charge which is extracted from the worst electric charge amount table through the interpolation. If the difference value exceeds a reference value, then the interpolation precision is judged as unreliable.

If the interpolation precision is unreliable, (NG in the step S5), in the step S6, then the computer adds the input waveform skew and load capacitance as the interpolation targets to the input waveform skews and load capacitances which the computer uses as the table parameters while executing the step S1. Then, the computer executes step S1. As a result, the steps S1 to S5 are executed again. Thereby, the worst amounts of electric charge corresponding to the input waveform skew and load capacitance are added to the worst electric charge amount table. In a case where, for example, the computer changes the numbers of time elements and load capacitances, from three to four and from four to five, respectively, the computer changes the number of the worst amounts of electric from 12 (3×4=12) to 20 (4×5=20). In addition, as resistance element names, the names of resistance elements corresponding to the worst amounts of electric charge as the interpolation targets are added to the resistance element name table. In this way, the precision of the EM reliability verification library is enhanced.

If the interpolation precision is reliable (OK in the step S5), then the computer generates an electric charge amount table 10 and an element name table 11. In this case, the computer sets the above-described worst electric charge amount table and resistance element name table as the electric charge amount table 10 and the element name table 11, respectively. The electric charge amount table 10 and the element name table 11 are used as part of the EM reliability verification library.

In the step S7, on the basis of a predetermined second formula (described later), the computer converts the multiple amounts of electric charge stored in the electric charge amount table 10 to multiple frequency limitation values, respectively. The computer generates an EM element frequency limitation table 12 in which multiple frequency limitation values are stored. The EM element frequency limitation table 12 is used as part of the EM reliability verification library.

Descriptions will be provided for the process of generating the HC reliability verification library (step S18). The step S18 includes steps S11 to S17, which will be described below.

In the step S11, by referring to the cell layout library, the computer extracts data on an input waveform skew and output load capacitance of each internal node, from the data on the cell. The internal node means any one of the gate, source and drain of each of multiple transistor elements. Examples of the multiple transistor elements include a MOS (metal oxide semiconductor) transistor (MOS Tr).

In the step 12, the computer extracts, as W sizes, the gate widths of the multiple transistor elements (in a direction other than the channel length direction of the transistor elements), from the data on the cell with reference to the cell layout library.

In the step S13, the computer makes a simulation on the basis of a predetermined third formula and the W sizes of the multiple transistor elements, and calculates multiple frequency limitation values for the respective multiple transistor elements.

In the step S14, the computer chooses, as the worst frequency limitation value, a frequency limitation value which is the worst (the largest in this case) among the multiple frequency limitation values. Then, the computer generates a worst frequency limitation value table in which the worst frequency limitation value is stored. Specifically, in the worst frequency limitation value, stored are a time element (unit: ns) as the input waveform skew, an output load capacitance (unit: pF) and the worst frequency limitation value (unit: MHz) corresponding to the time element and the output load capacitance. In a case where the number of time elements is three whereas the number of load capacitances is four, the number of worst frequency limitation values is 12 (3×4=12). The computer chooses, as the worst transistor element, a transistor element corresponding to the worst frequency limitation value. Then, the computer generates a transistor element name table in which the name of the worst transistor element (the transistor element name) is stored. The worst frequency limitation value table and the transistor element name table are used as part of the HC reliability verification library.

In the step S15, the computer checks interpolation precision of the worst frequency limitation value table and the transistor element name table. In this case, the interpolation precision means a degree of precision of interpolating the worst frequency limitation value corresponding to an input waveform skew and output load capacitance not included in the worst frequency limitation value table. The interpolation precision needs to be checked for the worst frequency limitation value table and the transistor element name table.

In the step S16, as a result of the check, the computer judges whether or not the interpolation precision is unreliable. The acceptability of the interpolation precision is judged on the basis of a difference value between the actual worst frequency limitation value corresponding to an input waveform skew and output load capacitance as the interpolation target, and the worst frequency limitation value which is extracted from the worst frequency limitation value table through the interpolation. If the difference value exceeds a reference value, then the interpolation precision is judged as unreliable.

If the interpolation precision is unreliable (NG in the step S16), in the step S17, then the computer adds the input waveform skew and output load capacitance as the interpolation targets to the input waveform skews and output load capacitances which the computer use as the table parameters while executing the step S11. Then, the computer executes step S11. As a result, the steps S11 to S15 are executed again. Thereby, the worst frequency limitation values corresponding to the input waveform skew and load capacitance are added to the worst frequency limitation value table. In a case where, for example, the computer changes the numbers of time elements and load capacitances, from three to four and from four to five, respectively, the computer changes the number of the worst frequency limitation values from 12 (3×4=12) to 20 (4×5=20). In addition, as transistor element names, the names of transistor elements corresponding to the interpolated worst frequency limitation values as the interpolation targets are added to the transistor element name table by the computer. Thereby, the precision of the HC reliability verification library is enhanced.

If the interpolation precision is reliable (OK in the step S16), then the computer generates an HC element frequency limitation table 14 and an element name table 13. In this case, the computer sets the above-described worst frequency limitation value table and transistor element name table as the element name table 13 and the HC element frequency limitation table 14. The element name table 13 and the HC element frequency limitation table 14 are used as part of the EM reliability verification library.

Descriptions will be provided for the process of generating the EM-HC reliability verification library (steps S20 to S22).

In the step S20, the computer merges the element name table 11 and the element name table 13 to generate an element name library table 15 as a first reliability verification library table. The names of the respective multiple resistance elements and the names of the respective multiple transistor elements are stored in the element name library table 15.

In the step S21, the computer merges the EM element frequency limitation table 12 and the HC element frequency limitation table 14 to generate a frequency limitation value library table 16 as a second reliability verification library table. The time elements (unit: ns) as the input waveform skews, the output load capacitances (unit: pF) and the worst frequency limitation values (unit: MHz) corresponding to the time elements and the output load capacitances are stored in the frequency limitation value library table 16.

In the step S22, by referring to the element name library table 15 and the frequency limitation value library table 16, the computer verifies the reliability of an LSI for the purpose of giving a guarantee in terms of both EM (electromigration) and HCs (hot carriers).

FIG. 2 shows an image diagram of the frequency limitation library table 16. For example, when an output load capacitance is “1 pF,” the frequency limitation values corresponding to time elements “1 ns,” “2 ns,” “4 ns” and “8 ns” are “1000 MHz,” “900 MHz,” “800 MHz” and “700 MHz,” respectively. When the output load capacitance is “2 pF,” the frequency limitation values corresponding to the time elements “1 ns,” “2 ns,” “4 ns” and “8 ns” are “900 MHz,” “800 MHz,” “700 MHz” and “700 MHz,” respectively. When the output load capacitance is “4 pF,” the frequency limitation values corresponding to the time elements “1 ns,” “2 ns,” “4 ns” and “8 ns” are “800 MHz,” “800 MHz,” “700 MHz” and “700 MHz,” respectively. When the output load capacitance is “8 pF,” the frequency limitation values corresponding to the time elements “1 ns,” “2 ns,” “4 ns” and “8 ns” are “700 MHz,” “700 MHz,” “700 MHz” and “600 MHz,” respectively. When the output load capacitance is “16 pF,” the frequency limitation values corresponding to the time elements “1 ns,” “2 ns,” “4 ns” and “8 ns” are “600 MHz,” “600 MHz,” “600 MHz” and “600 MHz,” respectively. For the purpose of verifying the reliability of each node inside the LSI, the computer checks the frequency at the node by use of this frequency limitation library table 16.

### SUMMARY

In general, when I, c, v and f denote an electric current, a capacitance, a voltage and a frequency limitation value, respectively, the electric current I can be figured out by the second formula I=cvf. In this respect, an amount Q of electric charge is expressed with c×v, and therefore, a frequency limitation value f is expressed with f=I/Q. Consequently, if a value of a tolerable electric current I is specified in the computer, then the computer can determine the amount Q of electric charge through a simulation, and accordingly calculate the frequency limitation value f.

How to calculate an amount Q of electric charge is, however, different depending on whether the electric current is a two-way electric current or a one-way electric current. By using FIG. 3, descriptions will be provided for the amount of electric charge for one period. FIG. 3 shows a case where a simulation is made for a certain resistance element, with time on the horizontal axis, and with electric current on the vertical axis. An amount Q of electric charge is equal to a value given by an integral of an electric current. For this reason, the area of a region on the + side constitutes Q+, whereas the area of a region on the − side constitutes Q−. In a case of a one-way electric current, the amount of electric charge for one period is equal to the sum of |Q+| and |Q−|. On the contrary, in a case of a two-way electric current, the direction in which the electric current flows alternately changes. For this reason, for the two-way electric current, it is sufficient to use a larger one of |Q+| and |Q−|, or instead, it is even possible to estimate a smaller value, in some cases. Thus, the related art verifies the reliability of an LSI by use of the worst amount of electric charge (a value of the electric current), and this means that the value of a one-way electric current is applied to the calculation of the amount of electric charge.

In the related art, the computer does not specify the direction in which the electric current flows in each metal interconnection element in the cell, when generating the EM element frequency limitation table 12. As a result, the computer inevitably uses the formula for a one-way electric current which produces a calculation result of frequency limitation values lower than those calculated by use of the formula for a two-way electric current. The reason for this is as follows. If a frequency limitation value is higher than a frequency actually tolerable for a transistor element, then the transistor element operates with the frequency exceeding its capability, so that its metal interconnection element breaks. Thus, even if a two-way electric current actually flows in the metal interconnection element (resistance element), the computer regards the two-way electric current as a one-way electric current, and generates an EM reliability verification library including the frequency limitation values lower than necessary. In this case, the EM reliability verification library is a library tolerable only for an operation with a low frequency value (only for a low-frequency operation). In other words, the low-frequency operation is imposed from a viewpoint of reliability guarantee. This is disadvantageous for designing a high-performance, high-speed LSI. As a result, the following problems occur. First, at the time of EM reliability verification, errors are detected in such a larger number of metal interconnection elements that a target operational frequency cannot be attained. Second, the overall area of the chip is increased by taking measures, such as buffer insertion, to avoid such errors.

In the recent microprocessing, interconnection pattern has been increasingly complicated due to higher integration of a cell. This situation produces several factors of not allowing an identification of the direction in which an electric current flows in each metal interconnection element in a cell. One of the factors is difficulty in exactly identifying the direction in which an electric current flows in each node. Another factor is an increase in a TAT (turn around time) for the identification (due to checking of the direction through a simulation, due to checking of the electric current direction through visual inspection, or due to other types of checking).

A method of generating a reliability verification library according to an exemplary aspect of the present invention generates a cell layout library in which data on a cell is stored. The cell includes multiple metal interconnection elements. The multiple metal interconnection elements include a first metal interconnection element group and a second metal interconnection element group. In the first metal interconnection element group, the metal interconnection elements are provided in a first direction, and an electric current flows, as a one-way electric current, in any one of the first direction and a direction opposite to the first direction. In the second metal interconnection element group, the metal interconnection elements are provided in a second direction, and an electric current flows, as a two-way electric current, in both of the second direction and a direction opposite to the second direction. By referring to the cell layout library, the method of generating a reliability verification library according to the present invention generates a net list in which data and on the first and second metal interconnection element groups are associated with corresponding resistance values of the first and second metal interconnection element groups, and corresponding identifiers representing the one-way and two-way electric currents.

The method of generating a reliability verification library specifies the direction in which an electric current flows in each of the multiple metal interconnection elements in each cell. In this case, a formula for a one-way electric current is applied to the first metal interconnection element group in which the one-way electric current flows, whereas a formula for a two-way electric current is applied to the second metal interconnection element group in which the two-way electric current flows. For this reason, a desired EM reliability verification library can be generated without generating an EM reliability verification library in which the frequency limitation values are represented lower than necessary. Furthermore, as compared to the case of applying the formula for a one-way electric current, applying the formula for a two-way electric current can reduce the amounts of electric charge, and thus increases the frequency limitation values. For this reason, the method of generating a reliability verification library is capable of solving one of the problems with the related art that the target operational frequency cannot be attained. Furthermore, once this problem is solved, measures such as the buffer insertion will be less likely to be taken, and therefore the other problem that the overall area of the chip is increased can be solved as well.

### BRIEF DESCRIPTION OF THE DRAWINGS

The above and other exemplary aspects, advantages and features of the present invention will be more apparent from the following description of certain exemplary embodiments taken in conjunction with the accompanying drawings, in which:

FIG. 1 is a flowchart showing the operation of a reliability verifier described in Japanese Patent No. 3722690 as a related method of generating a reliability verification library;

FIG. 2 shows an image diagram of a frequency limitation value library table;

FIG. 3 shows an image diagram used to explain an amount of electric charge for one period;

FIG. 4 shows a configuration of a system which a method of generating a reliability verification library according to each exemplary embodiment of the present invention is applied to;

FIG. 5 is a flowchart showing a process of generating an EM reliability verification library (step S8) included in a method of generating a reliability verification library according to a first exemplary embodiment of the present invention;

FIG. 6 shows an example of a net list used in the method of generating a reliability verification library according to the first exemplary embodiment of the present invention;

FIG. 7 shows details of the net list used in the method of generating a reliability verification library according to the first exemplary embodiment of the present invention;

FIG. 8 shows a diagram of a configuration (a diagram of an equivalent circuit) of a buffer cell used to explain a step S27 included in the process of generating an EM reliability verification library (step S8) included in the method of generating a reliability verification library according to the first exemplary embodiment of the present invention;

FIG. 9 shows a layout diagram of the buffer cell shown in FIG. 8;

FIG. 10 shows electric current paths in the layout diagram shown in FIG. 9;

FIG. 11 shows how electric current flows in each metal interconnection element in the cell, on the basis of the electric current paths in the layout diagram shown in FIG. 10;

FIG. 12 is a diagram obtained by applying, to the diagram shown in FIG. 9, the method of generating a reliability verification library according to the first exemplary embodiment of the present invention, and shows a case where a one-way electric current is defined as flowing in a first metal interconnection element group provided in the vertical direction, and a two-way electric current is defined as flowing in a second metal interconnection element group provided in the horizontal direction;

FIG. 13A is a diagram used to explain the method of generating a reliability verification library according to the first exemplary embodiment of the present invention, and shows an example of a frequency limitation library table obtained by defining a one-way electric current as flowing in all the metal interconnection elements;

FIG. 13B is a diagram used to explain the method of generating a reliability verification library according to the first exemplary embodiment of the present invention, and shows an example of a frequency limitation library table obtained by defining a two-way electric current as flowing in all the metal interconnection elements;

FIG. 13C is a diagram used to explain the method of generating a reliability verification library according to the first exemplary embodiment of the present invention, and shows an example of a frequency limitation library table obtained by defining a one-way electric current as flowing in each of the vertically-provided metal interconnection elements, and concurrently by defining a two-way electric current as flowing in each of the horizontally-provided metal interconnection elements, which is a scheme characteristic of the present invention;

FIG. 14 is a flowchart showing a process of generating an EM reliability verification library (step S8) included in a method of generating a reliability verification library according to a second exemplary embodiment of the present invention;

FIG. 15 shows a diagram of a layout of an inverter cell used to explain a step S28 included in the process of generating an EM reliability verification library (step S8) included in the method of generating a reliability verification library according to the second exemplary embodiment of the present invention;

FIG. 16 shows how an electric current flows in each metal interconnection element in a cell, on the basis of electric current paths shown in the layout diagram of FIG. 15 (with a location of an external connection node 107 being assumed as a connection location L1);

FIG. 17 shows how an electric current flows in each metal interconnection element in the cell, on the basis of the electric current paths shown in the layout-diagram of FIG. 15 with the location of the external connection node 107 being assumed as a connection location L2;

FIG. 18 shows how an electric current flows in each metal interconnection element in the cell, on the basis of the electric current paths shown in the layout diagram of FIG. 15 with the location of the external connection node 107 being assumed as a connection location L3;

FIG. 19 is a flowchart showing a process of generating an EM reliability verification library (step S8) included in a method of generating a reliability verification library according to a third exemplary embodiment of the present invention;

FIG. 20 shows a diagram of a layout of a buffer cell used to explain a step S29 included in the process of generating an EM reliability verification library (step S8) included in the method of generating a reliability verification library according to the third exemplary embodiment of the present invention;

FIG. 21 is a diagram obtained by applying, to the diagram shown in FIG. 20, the method of generating a reliability verification library according to the third exemplary embodiment of the present invention, and shows a case where a one-way electric current is defined as flowing in a first metal interconnection element group provided in the vertical direction, and a two-way electric current is defined as flowing in a second metal interconnection element group provided in the horizontal direction;

FIG. 22 is a flowchart showing a process of generating an EM reliability verification library (step S8) included in a method of generating a reliability verification library according to a fourth exemplary embodiment of the present invention; and

FIG. 23 shows a diagram of a layout of a buffer cell used to explain a step S30 included in the process of generating an EM reliability verification library (step S8) included in the method of generating a reliability verification library according to the fourth exemplary embodiment of the present invention.

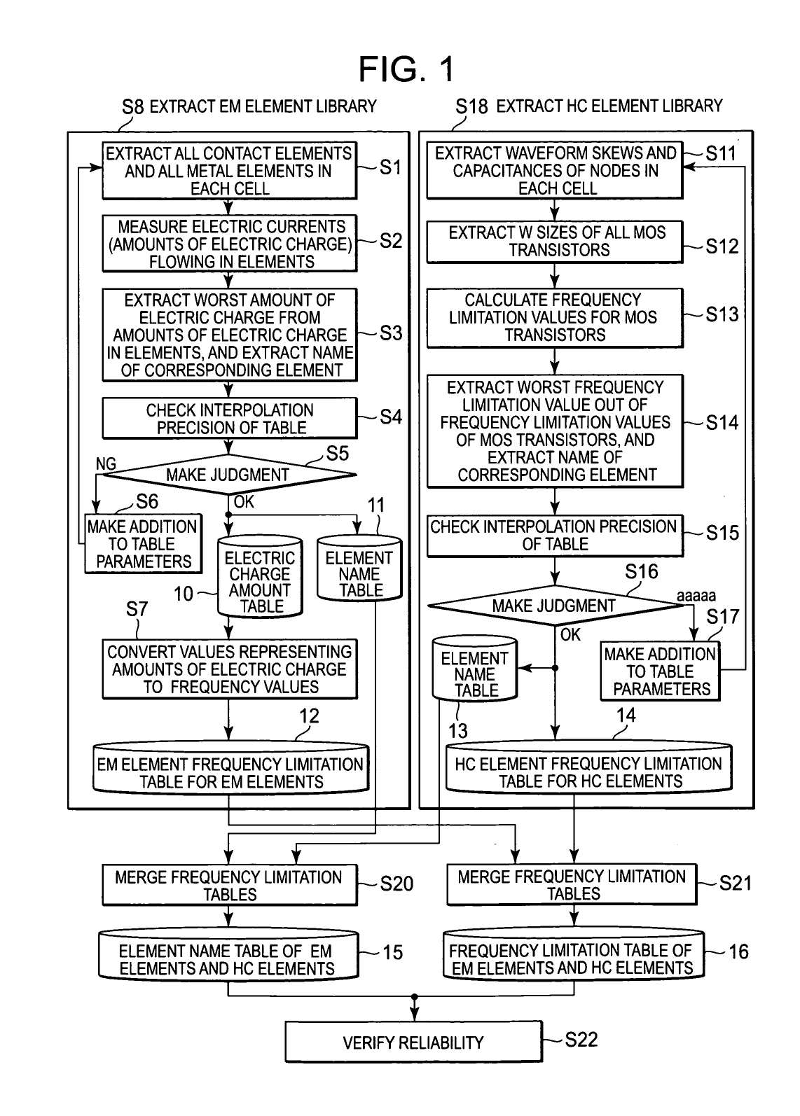

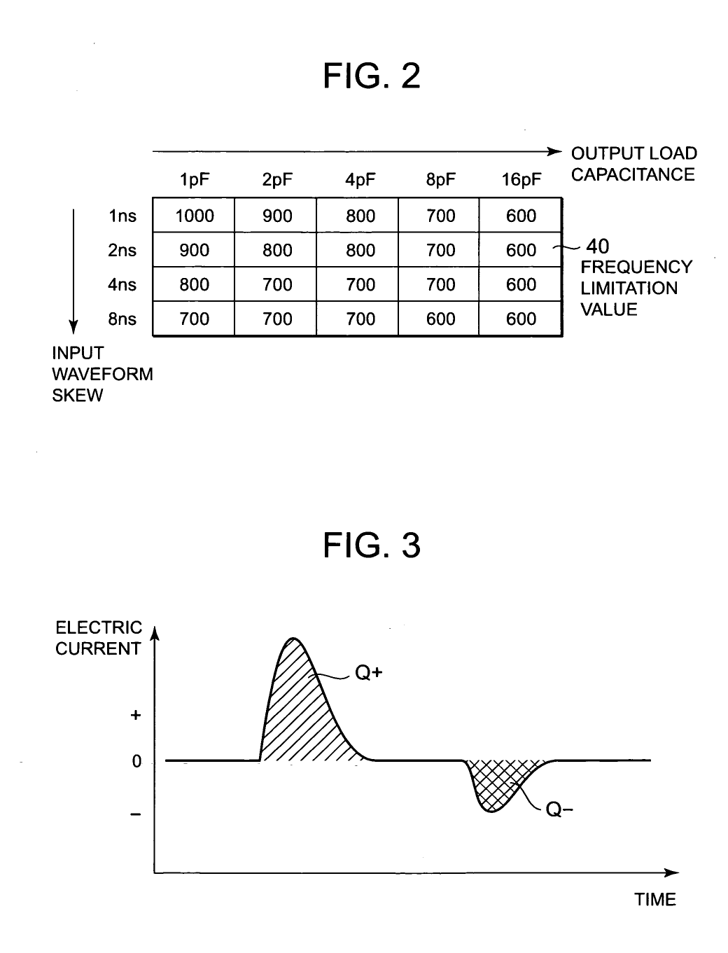

### DETAILED DESCRIPTION OF THE EXEMPLARY EMBODIMENTS

### First Exemplary Embodiment

### [Configuration]

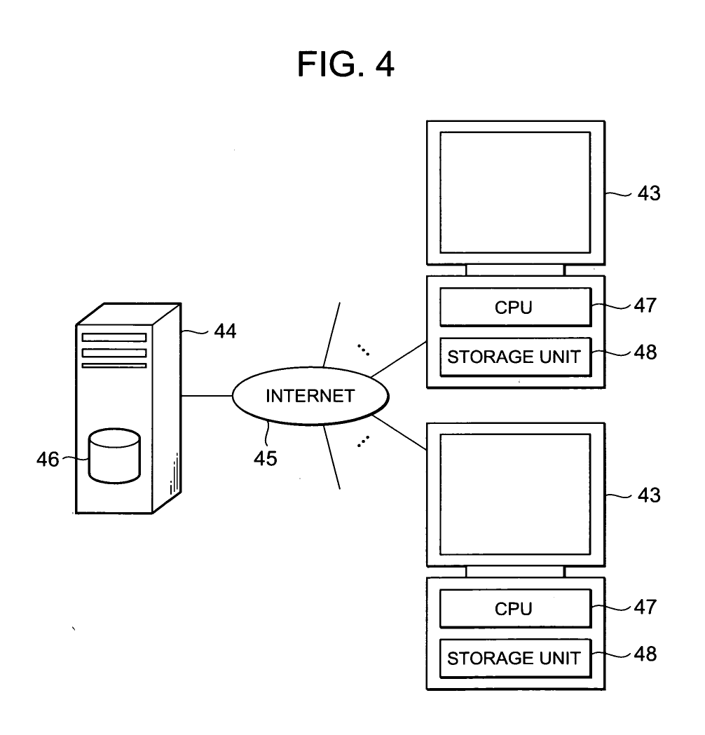

FIG. 4 shows a configuration of a system to which the method of generating a reliability verification library according to an exemplary embodiment of the present invention is applied. This system includes computer apparatuses (hereinafter referred to as “computers”) 43 such as engineering workstations, and a server 44.

The server 44 is connected to the computer apparatuses 43 through a network 45 such as the Internet. The server 44 includes a recording medium 46. A computer program (a program for generating a reliability verification library) configured to realize the method of generating a reliability verification library is stored in the recording medium 46. The program for generating a reliability verification library is downloaded from the server 46 to the computers 43 through the network 45.

Each computer 43 includes: a CPU (central processing unit) 47 serving as a controller; and a local storage unit 48 such as a hard disc and a memory. The program for generating a reliability verification library is stored in the storage unit 48 when downloaded to the computer 43. When the computer 43 is activated, or receives instructions from a user, for example, the CPU 47 reads the program for generating a reliability verification library from the storage unit 48, and executes the program.

In addition, libraries described later are stored in the storage unit 48.

### [Operation]

The CPU 47 executes the process of generating an EM reliability verification library (step S8), the process of generating an HC reliability verification library (step S18), and the process of generating an EM-HC reliability verification library (steps S20 to S22) which are described above. Here, descriptions of the present invention will be provided only for points that are different from the method of generating a reliability verification library according to the related art.

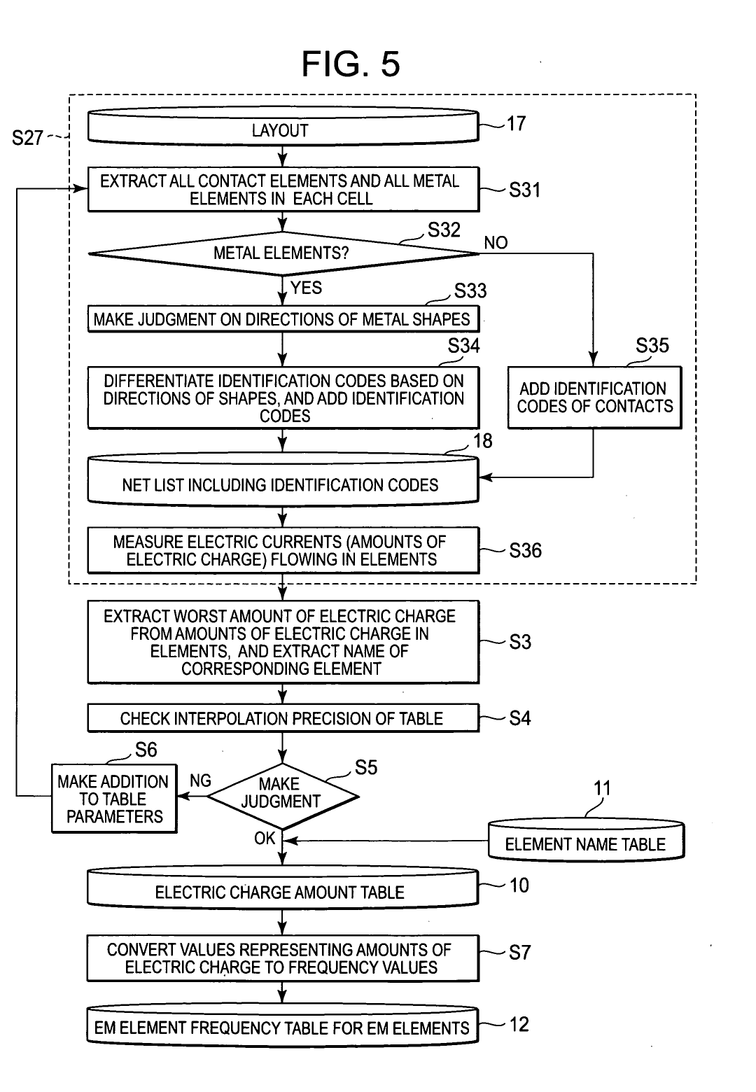

FIG. 5 is a flowchart showing the process of generating an EM reliability verification library (step S8) included in the method of generating a reliability verification library according to the first exemplary embodiment of the present invention.

In the step S8, the CPU 47 executes a step S27 instead of the steps S1 and S2, which have been described above. The step S27 includes a resistance extracting step S31, a determination step S32, a metal shape-direction judging step S33, a metal identification code adding step S34, an identification code adding step S35, and an electric charge amount measuring step S36.

First of all, a cell layout library 17 is generated. Layout date is stored in the cell layout library 17. The layout data includes data on the cell. The cell layout library 17 is used as part of the EM reliability verification library.

In the resistance extracting step S31, by referring to the cell layout library 17, the CPU 47 extracts data on all of the resistance elements from the data on the cell. The cell includes multiple resistance elements as all of the resistance elements. Of the multiple resistance elements, resistance elements of first and second resistance element groups represent resistances of metal interconnection elements, which are provided in first and second directions, respectively, out of the multiple metal interconnection elements. The metal interconnection elements provided in the first and second directions constitute first and second metal interconnection element groups, respectively. Of the multiple resistance elements, resistance elements of a third resistance element group respectively represent resistances of multiple contact elements connected to the multiple metal interconnection elements. In the first metal element group, an electric current is defined as flowing, as a one-way electric current, in the first direction or a direction opposite to the first direction while the cell is operating. In addition, in the second metal element group, the electric current is defined as flowing, as a two-way electric current, alternately in the second direction and a direction opposite to the second direction while the cell is operating.

In this respect, the second direction is a direction perpendicular to the first direction. For example, the vertical and horizontal directions in the layout are defined as the first and second directions, respectively.

In the determination step S32, the CPU 47 judges whether or not each of the multiple resistance elements is a metal interconnection element.

Of the multiple resistance elements, resistance elements of the first and second resistance element groups are metal interconnection elements. In other words, the first and second resistance element groups represent the resistances of the first and second metal interconnection element groups (in a case of Yes in the step S32). In this case, the CPU 47 proceeds to the metal shape-direction judging step S33, and judges which direction each of the first and second metal interconnection element groups is provided in. In this respect, the first and second metal interconnection element groups are provided in the vertical and horizontal directions, respectively. The one-way electric current is defined as flowing in the metal interconnection element group provided in the vertical direction. The two-way electric current is defined as flowing in the metal interconnection element group in the horizontal direction.

In the metal identification code adding step S34, the CPU 47 generates a net list 18 including identification codes (hereinafter referred to as a “net list 18”) in which data on the first metal interconnection element group, a resistance value of the first metal interconnection element group and an identifier (hereinafter referred to as an “identification code”) representing the one-way electric current are associated together. In addition, the CPU 47 associates together data on the second metal interconnection element group, a resistance value of the second metal interconnection element group and an identification code representing the two-way electric current in the net list 18. The net list 18 is used as part of the EM reliability verification library.

Of the multiple resistance elements, resistance elements of neither the first nor second resistance element group are not metal interconnection elements. In other words, resistance elements of the third resistance element group represent resistances of the multiple contact elements (in a case of No in the step S32). In this case, the CPU 47 proceeds to the identification code adding step S35, and further associates sets of data on the multiple contact elements with resistance values of the multiple contact elements, respectively, in the net list 18.

In the electric charge amount measuring step S36, by referring to the net list 18, the CPU 47 makes a simulation on the basis of the predetermined first formula, the resistance values of the first and second metal interconnection element groups, the identification codes representing the one-way and two-way electric currents of the first and second metal interconnection element groups, and the resistance values of the multiple contact elements. Then, the CPU 47 calculates an electric current consumption which is consumed by the cell. At this time, as multiple amounts of electric charge, electric currents (amounts of electric charge) flowing in the multiple resistance elements (the first and second metal interconnection element groups as well as the multiple contact elements) inside the cell are sampled by the CPU 47.

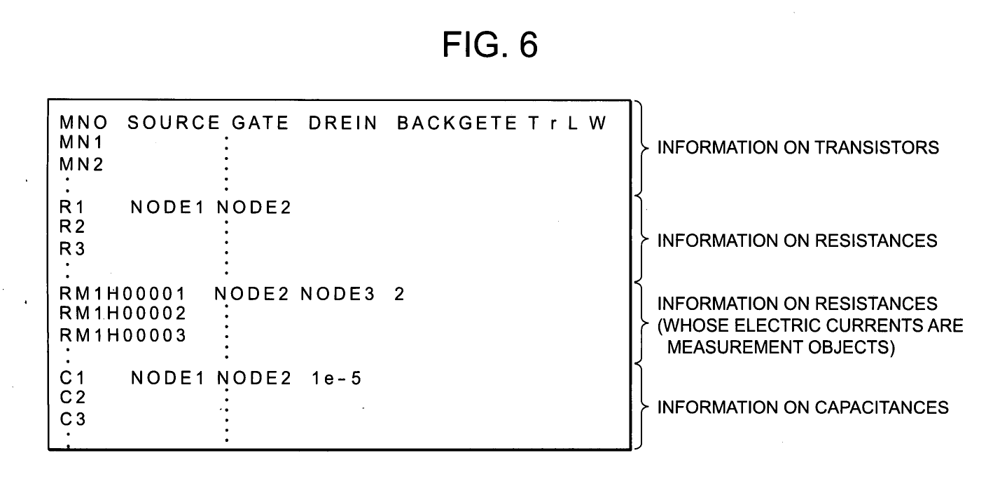

FIG. 6 shows an example of the net list 18. A general net list includes information on a transistor, information on a resistance element and information on a capacitance element. The net list 18 also includes the sets of information included in the general net list. In addition, when the resistance element is a metal interconnection element, the information on the resistance element included in the net list 18 further includes an identification code representing a direction in which the metal interconnection element is directed (corresponding to either the one-way electric current or the two-way electric current).

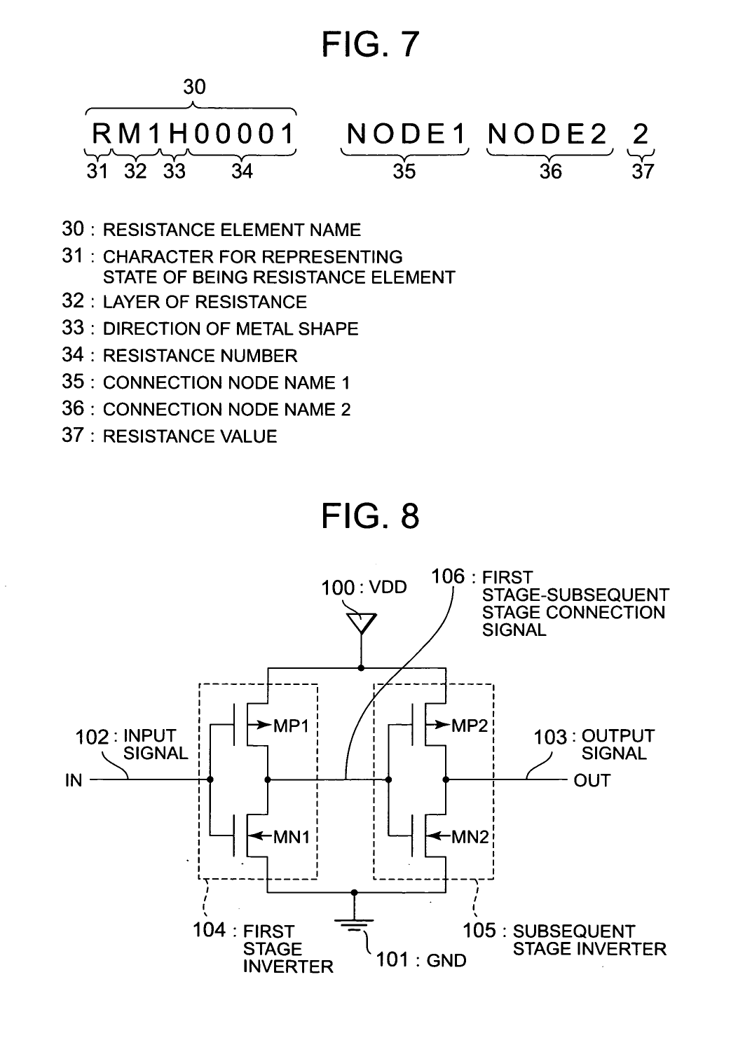

As shown in FIG. 7, the information on a resistance element includes: a character string 30 for representing a resistance element name, which is the name of the resistance element; a character string 35 for representing a connection node name 1, which is the name of a node connected to the two ends of the resistance element; a character string 36 for representing a connection node name 2; and a character string 37 for representing the resistance value of the resistance element. The character string 30 for representing a resistance element name includes: a character string 31 for representing the state of being a resistance element; and a character string 34 for representing a resistance number for identifying the resistance element.

The character string 30 for representing a resistance element name further includes a character string 32 for representing a layer of a resistance element. The “layer” herein means any one of wells, metals and the like which are used when the layout is designed.

When the resistance element represents a metal interconnection element of the first metal interconnection element group, the character strings 31, 32, 34 are used as data on the first metal interconnection element group. When the resistance element represents a metal interconnection element of the second metal interconnection element group, the character strings 31, 32, 34 are used as data on the second metal interconnection element group. When the resistance element represents one of the multiple contact elements, the character strings 31, 32, 34 are used as data on the multiple contact elements.

The character string 30 for representing a resistance element name further includes a character string 33 for representing a direction. The character string 33 for representing a direction indicates one of a character V representing the vertical direction, a character H representing the horizontal direction, and a character other than the characters V, H. In a case where, for example, the resistance element is judged as representing one of the metal interconnection elements of the first metal interconnection element group on the basis of information on a coordinate system and the like which the CPU 47 obtains by referring to the cell layout library 17, the character string 33 for representing a direction indicates the character V representing the vertical direction, because the direction in which the first metal interconnection element group is provided is vertical. In a case where the resistance element is judged as representing one of the metal interconnection elements of the second metal interconnection element group on the basis of information on a coordinate system and the like which the CPU 47 obtains by referring to the cell layout library 17, the character string 33 for representing a direction indicates the character H representing the horizontal direction because the direction in which the second metal interconnection element group is provided is horizontal. In a case where the resistance element is judged as representing one of the multiple contact elements, the character string 33 for representing a direction indicates a character other than the characters H, V.

When the resistance element represents a metal interconnection element of the first metal interconnection element group, the character string 33 is used as the identification code representing the one-way electric current. When the resistance element represents a metal interconnection element of the second metal interconnection element group, the character string 33 is used as the identification code representing the two-way electric current.

In the metal shape-direction judging step S33, as described above, by referring to the cell layout library 17, the CPU 47 judges whether the resistance element is formed in a vertical shape or in a horizontal shape, on the basis of the information on the coordinate system and the like. Then, the CPU 47 adds the judgment result to the net list 18 in the metal identification code adding step S34.

Subsequently, in the electric charge amount measuring step S36, when the identification code represents the one-way electric current, the CPU 47 calculates the electric current (amount of electric charge) by using the formula for the one-way electric current (i.e., an amount of electric charge=|Q+|+|Q−|) as the predetermined first formula. When the identification code represents the two-way electric current, the CPU 47 calculates the electric current (amount of electric charge) by using the formula for the two-way electric current (i.e., an amount of electric charge=|Q+| or |Q−|, whichever is larger) as the predetermined first formula.

As described above, in the process of generating an EM reliability verification library (step S8), the CPU 47 executes the step S27, and thereby calculates the amount of electric charge by use of the net list 18. Thereafter, the CPU 47 executes the step 3 and the ensuing steps.

### [Effects]

Descriptions will be provided for effects brought about by the method of generating a reliability verification library according to the first exemplary embodiment of the present invention.

The related art does not specify the direction in which the electric current flows in each metal interconnection element in the cell. As a result, the computer inevitably applies the formula for a one-way electric current to the calculation of an amount of electric charge, so that frequency limitation values resulting from the calculation are lower than those resulting from the calculation to which the formula for a two-way electric current is applied. The reason for this is as follows. In a case where a frequency limitation value is higher than a frequency actually tolerable for a transistor element, the transistor element operates with the frequency exceeding its capability, so that its metal interconnection element breaks. Thus, even if a two-way electric current actually flows in the metal interconnection element (resistance element), the computer regards the two-way electric current as a one-way electric current. As a result, the computer generates an EM reliability verification library in which the frequency limitation value for the metal interconnection element is represented lower than necessary. In this case, the EM reliability verification library is a library tolerable only for the operation with a low frequency value (only for a low-frequency operation). In other words, the low-frequency operation is imposed from a viewpoint of reliability guarantee. This is disadvantageous for designing a high-performance, high-speed LSI. As a result, the following problems occur. First, at the time of EM reliability verification, errors are detected in such a larger number of metal interconnection elements that a target operational frequency cannot be attained. Second, the overall area of the chip is increased by taking measures, such as buffer insertion, to avoid such errors.

On the contrary, the method of generating a reliability verification library according to the first exemplary embodiment of the present invention specifies the direction in which an electric current flows in each of the multiple metal interconnection elements in each cell. In this case, the computer 43 applies the formula for the one-way electric current to the multiple metal interconnection elements in the first metal interconnection element group in which the one-way electric current flows, whereas the computer 43 applies the formula for the two-way electric current to the multiple metal interconnection elements in the second metal interconnection element group in which the two-way electric current flows. For this reason, the computer 43 is capable of generating a desired EM reliability verification library without generating an EM reliability verification library in which the frequency limitation values are represented lower than necessary. Furthermore, the application of the formula for the two-way electric current reduces the amounts of electric charge, hence increasing the frequency limitation values, compared to the case where the formula for the one-way electric current is applied. For this reason, it is possible to solve one of the problems that the target operational frequency cannot be attained. Furthermore, once this problem is solved, the measures such as the buffer insertion will be less likely to be taken, and therefore the other problem that the overall area of the chip is increased can be solved as well.

As described above, the method of generating a reliability verification library according to the first exemplary embodiment of the present invention is capable of generating a desired EM reliability verification library with a precision satisfying the actual operation, and with a high reliability.

In addition, the method of generating a reliability verification library according to the first exemplary embodiment of the present invention keeps the size of each metal interconnection element in each cell to the minimum necessary, and does not increase the cell size wastefully.

Furthermore, the method of generating a reliability verification library according to the first exemplary embodiment of the present invention satisfies the frequency which is targeted when the reliability of the chip is verified, and thus enhances its speed performance.

Moreover, the method of generating a reliability verification library according to the first exemplary embodiment of the present invention reduces the number of metal interconnection elements evaluated as defective when the reliability of the chip is verified, and thus an increase in the size of the LSI caused by buffer insertion and the like can be reduced.

Besides, the method of generating a reliability verification library according to the first exemplary embodiment of the present invention reduces time needed to make a simulation for judging which type of electric current (the one-way electric current or two-way electric current) flows in each metal interconnection element, and concurrently reduces time needed to evaluate the result of the simulation. For example, in a case where one month is required to make a simulation for measuring the amounts of electric charge for the respective 100 cells and to apply an AC/DC electric current analysis to the result of extracting the amounts of electric charge (in a case of one month@100 cells), the present invention is capable of conducting the same simulation and analysis within a length of time much shorter than one-month.

### [Demonstration]

FIG. 8 is a diagram of an equivalent circuit of a generally function cell with a buffer theory (hereinafter referred to as a “buffer cell”). The buffer cell includes a first stage inverter 104 and a subsequent stage inverter 105.

Each of the first stage inverter 104 and the subsequent stage inverter 105 includes a P channel transistor and an N channel transistor which are connected together in series. The gates respectively of the P channel transistor and the N channel transistor of the first stage inverter 104 constitute an input of the first stage inverter 104. The drains respectively of the P channel transistor and the N channel transistor of the first stage inverter 104 constitute an output of the first stage inverter 104. The gates respectively of the P channel transistor and the N channel transistor of the subsequent stage inverter 105 constitute an input of the subsequent stage inverter 105. The drains respectively of the P channel transistor and the N channel transistor of the subsequent stage inverter 105 constitute an output of the subsequent stage inverter 105. The output of the first stage inverter 104 is connected to the input of the subsequent inverter 105. An input signal 102 is supplied to the input of the first stage inverter 104. The first stage inverter 104 inverts the signal level of the input signal 102, and outputs the resultant signal as a first stage-subsequent stage connection signal 106. The first stage-subsequent stage connection signal 106 is supplied to the input of the subsequent stage inverter 105. The subsequent stage inverter 105 inverts the signal level of the first stage-subsequent stage connection signal 106, and outputs the resultant signal as an output signal 103.

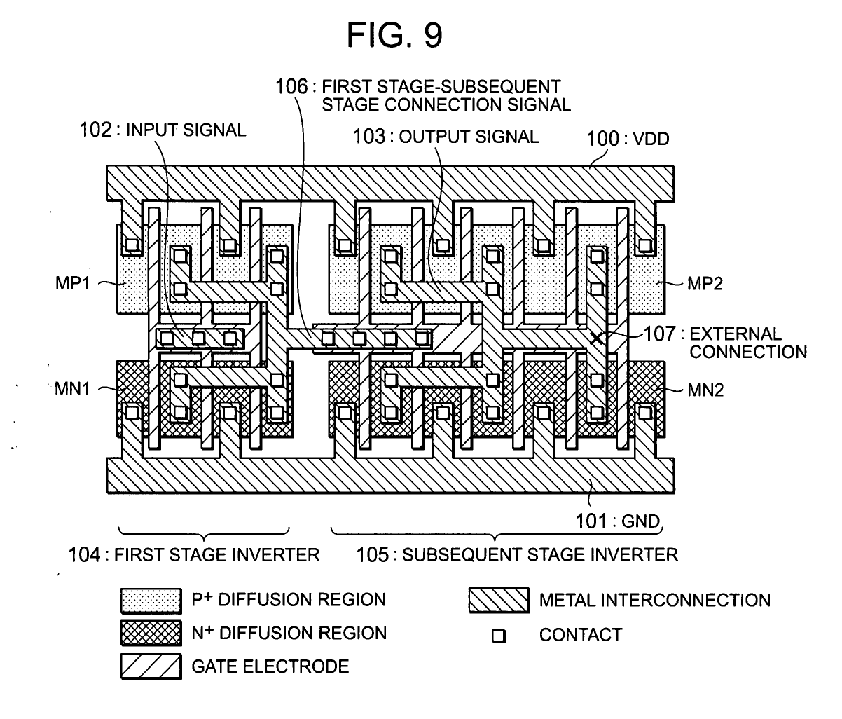

FIG. 9 shows a diagram of a layout of the buffer cell. FIG. 9 shows a high-drive buffer cell including many transistors for the purpose of making the electric current paths in the buffer cell understood clearly. Multiple metal interconnection elements are provided on the P channel transistors (a P+ diffusion region MP1 and a P+ diffusion region MP2) and the N channel transistors (an N+ diffusion region MN1 and an N+ diffusion region MN2). Here, it is assumed that the widths of the respective multiple metal interconnection elements are equal to one another.

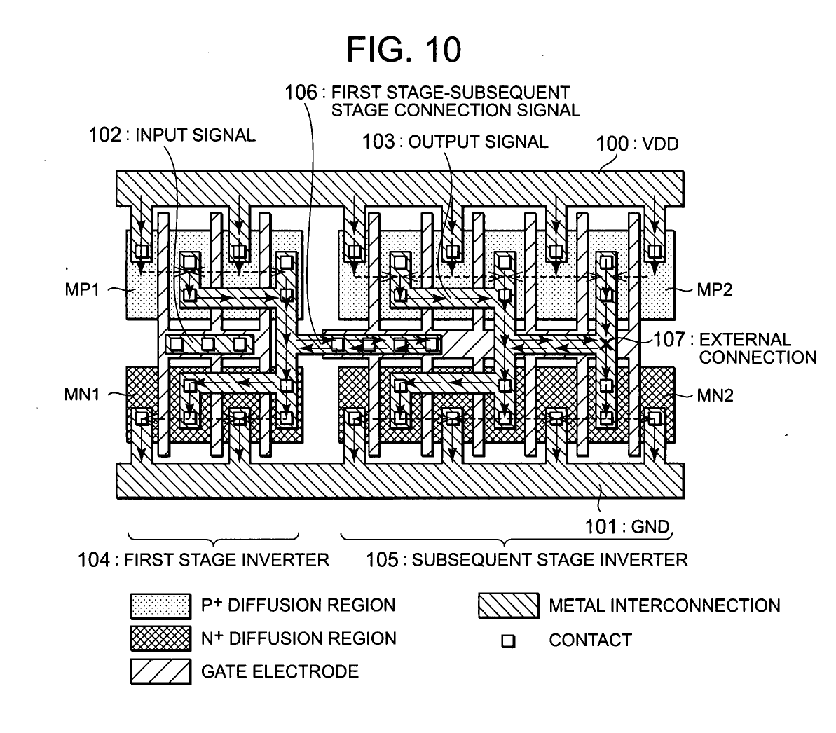

In FIG. 10, arrows indicate directions in which the electric currents flow in the buffer cell shown in FIG. 9. The output signal 103 is outputted through an external connection node 107. Assume that the external connection node 107 is a place which is connected to the outside of the cell when a simulation is made to measure amounts of electric charge. The electric current paths on each metal interconnection element are indicated by solid lines. The electric current paths passing gate electrodes are indicated by broken lines. The one-way electric current flows in metal interconnection elements, on which only arrows directed in one direction are shown, out of the multiple metal interconnection elements. The two-way electric current flows in metal interconnection elements, on which both arrows directed in one direction and arrows directed in the other direction are shown, out of the multiple metal interconnection elements. A metal interconnection element in which the first stage-subsequent stage connection signal 106 flows and a metal interconnection element in which the output signal 103 flows are the only metal interconnection elements in which the two-way electric currents flow. In the related art, the calculation is performed under the assumption that the one-way electric current flows in these metal interconnection elements as well, thus making the EM reliability verification library tolerable only for the low-frequency operation.

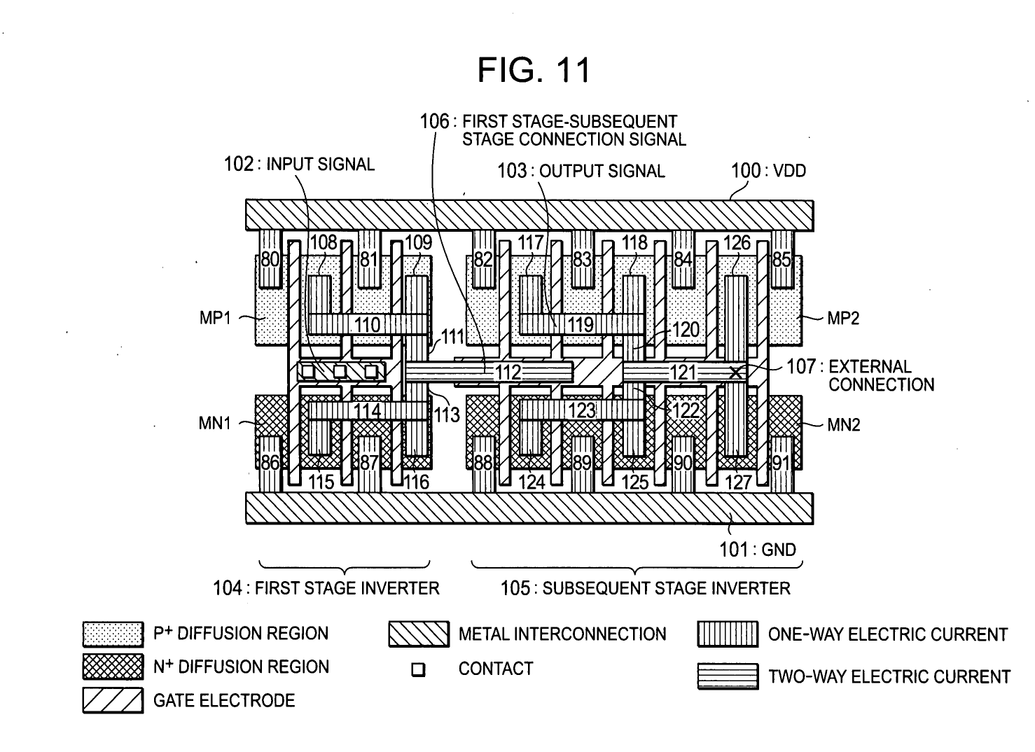

FIG. 11 shows how electric current flows in each metal interconnection element in the cell, on the basis of the electric current paths in the layout diagram shown in FIG. 10. Here, it is assumed that the multiple metal interconnection elements include multiple metal interconnection elements 80 to 91 and 108 to 127. The metal interconnection elements 80 to 85 are connected to a first voltage supply VDD100. The metal interconnection elements 86 to 91 are connected to a second voltage supply GND101. The two-way electric current flows in only the metal interconnection element 112 and the metal interconnection element 121 out of the multiple metal interconnection elements 80 to 91 and 108 to 127. The one-way electric current flows in the other metal interconnection elements 80 to 91, 108 to 111, 113 to 120 and 122 to 127. The metal interconnection element 121 is used to output the output signal 103. It is assumed herein that the metal interconnection element 121 is provided with the external connection node 107.

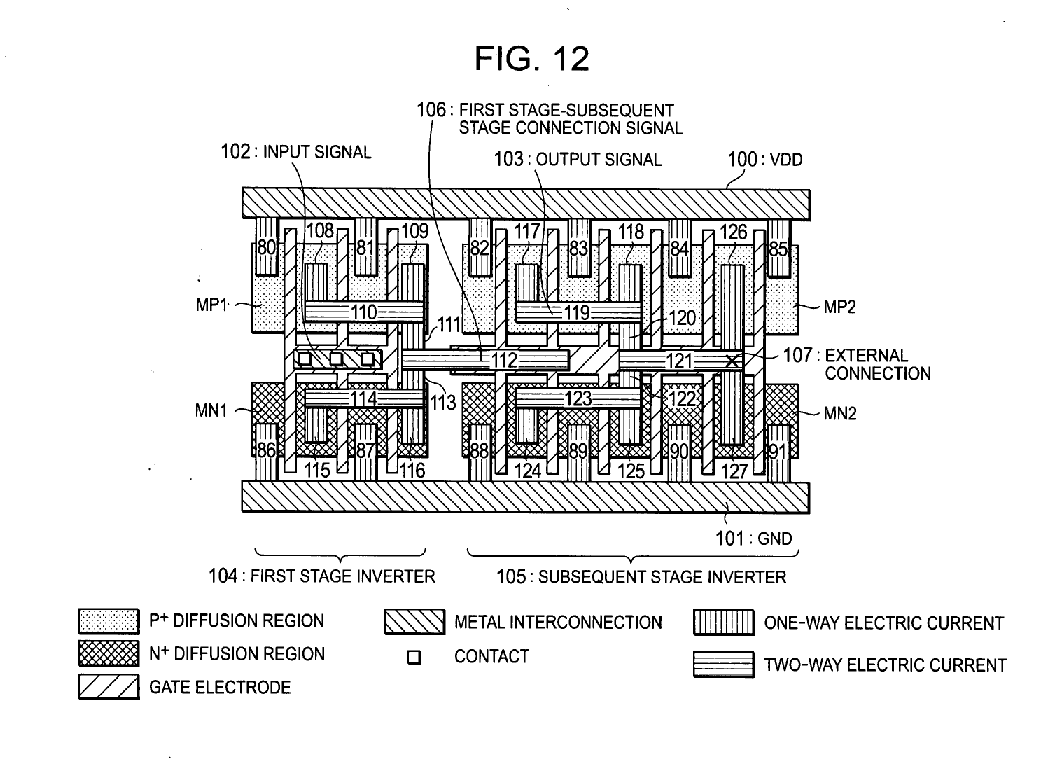

FIG. 12 is a diagram in which: the one-way electric current is defined as flowing in the first metal interconnection element group provided in the vertical direction; and the two-way electric current is defined as flowing in the second metal interconnection element group provided in the horizontal direction.

Here, it is assumed that: the first metal interconnection element group consists of metal interconnection elements 80 to 91, 108, 109, 111, 113, 115, 116, 117, 118, 120, 122, 124, 125, 126 and 127 out of the multiple metal interconnection elements 80 to 91 and 108 to 127; and the second metal interconnection element group consists of metal interconnection elements 110, 112, 114, 119, 121 and 123. In this case, although FIG. 11 shows that the one-way electric current actually flows in the metal interconnection elements 110, 114, 119 and 123, the two-way electric current which is of a type different from the one-way electric current shown in FIG. 11 is defined as flowing in the metal interconnection elements 110, 114, 119 and 123. This may give an impression that the EM reliability verification library would serve as a library allowing an operation to be performed with a high-frequency value higher than an actually tolerable frequency value (allowing a high-frequency operation to be performed). However, this is not the case. Specifically, the EM reliability verification library is not a loose library, if it is defined that the entire electric current flowing in the metal interconnection element 110 flows into the metal interconnection element 111, then the entire electric current flowing in, the metal interconnection element 114 flows from the metal interconnection element 113, and the electric current flowing in each of the metal interconnection elements 111, 113 is defined as the one-way electric current. The same is true, if it is defined that the entire electric current flowing in the metal interconnection element 119 flows into the metal interconnection element 120, and the electric current flowing in the metal interconnection element 123 flows from the metal interconnection element 122.

A function cell with a CMOS structure always includes a vertically-provided metal interconnection element connecting a P channel transistor and an N channel transistor together (when the P channel transistor and the N channel transistor are laid in a vertical direction). For this reason, the EM reliability verification library works as an adequate library (a library with high precision to satisfy the actual operation) but-not as a library allowing the high-frequency operation to be performed, even if the one-way electric current is defined as flowing in the vertically-provided metal interconnection element in which a penetration electric current (one-way electric current) is prone to flow, and also the two-way electric current is defined as flowing in the horizontally-provided metal interconnection element. Depending on a layout pattern, a one-way electric current may flow in a horizontally-provided metal interconnection element. However, the one-way electric current always flows in a vertically-provided metal interconnection element as an electric current path. Thus, the calculation should be made under the assumption that the one-way electric current flows in each vertically-provided metal interconnection element. In this way, even if the calculation is made under the assumption that the two-way electric current flows in each horizontally-provided metal interconnection elements, the EM reliability verification library allows no high-frequency operation to be performed because the process of generating the EM reliability verification library is carried out in accordance with step S3 and the ensuring steps which have been described above. This scheme makes it possible to solve one of the problems that the direction in which an electric current flows in each metal interconnection element in the cell cannot be specified.

Note that the condition for making this exemplary embodiment workable is that the widths of the multiple metal interconnection elements are equal to one another. Usually, multiple metal interconnection elements having unequal widths bring about a disadvantage to a highly integrated cell in terms of its cell size, and thus the mainstream of function cells is that the widths of the metal interconnection elements are made equal to one another.

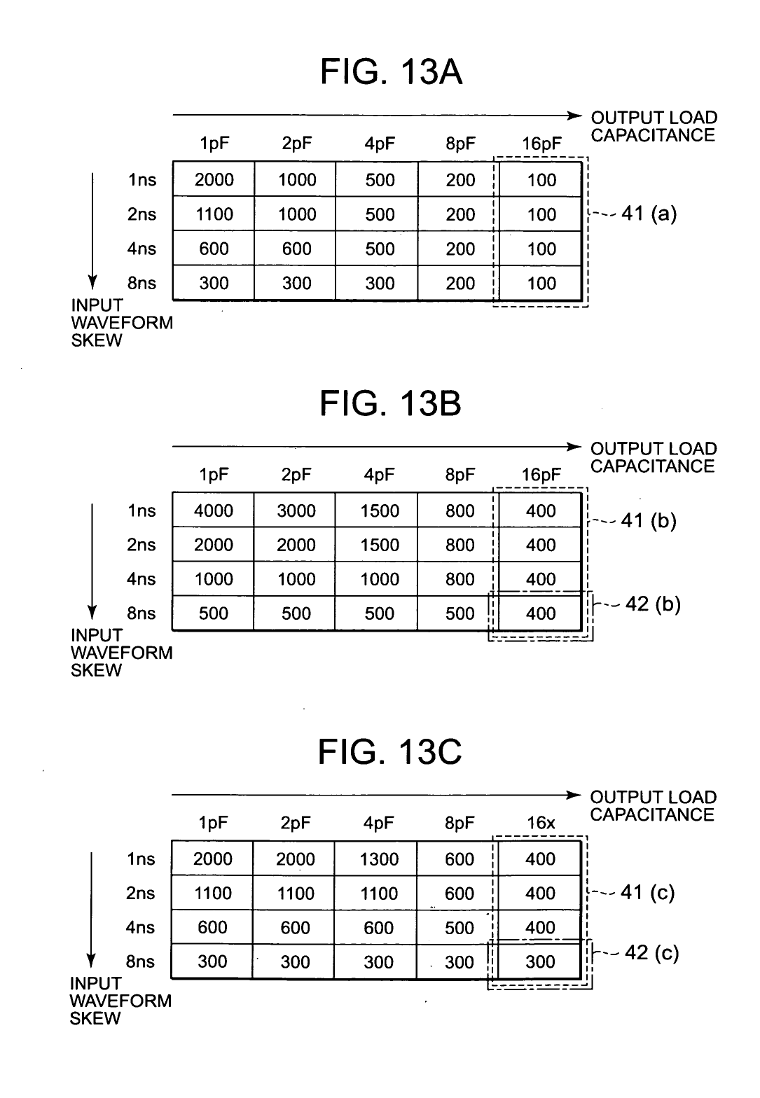

FIGS. 13A to 13C each show an example of the frequency limitation library table 16 as a reliability verification library in a case where the defined electric current type in a high-drive type buffer cell is changed. As shown in FIGS. 13A to 13C, multiple time elements (unit: ns) representing the input waveform skews, multiple output load capacitances (unit: pF) as well as multiple frequency limitation values (unit: MHz) corresponding to the multiple time elements and the multiple output load capacitances, are stored in the frequency limitation library table 16.

FIG. 13A shows an example of the frequency limitation library table 16 in a case where the one-way electric current is defined as flowing in all the metal interconnection elements. The related art applies the formula for the one-way electric current to all the metal interconnection elements. As a result, as shown in FIG. 13A, the frequency limitation library table 16 is generated as a library whose frequency limitation values are lower than actually tolerable frequencies. For example, when an output load capacitance is “1 pF,” the frequency limitation values corresponding to time elements “1 ns,” “2 ns,” “4 ns” and “8 ns” are “2000 MHz,” “1100 MHz,” “600 MHz” and “300 MHz,” respectively. When the output load capacitance is “2 pF,” the frequency limitation values corresponding to the time elements “1 ns,” “2 ns,” “4 ns” and “8 ns” are “1000 MHz,” “1000 MHz,” “600 MHz” and “300 MHz,” respectively. When the output load capacitance is “4 pF,” the frequency limitation values corresponding to the time elements “1 ns,” “2 ns,” “4 ns” and “8 ns” are “500 MHz,” “500 MHz,” “500 MHz”and “300 MHz,” respectively. When the output load capacitance is “8 pF,” the frequency limitation values corresponding to the time elements “1 ns,” “2 ns,” “4 ns” and “8 ns” are “200 MHz,” “200 MHz,” “200 MHz” and “200 MHz,” respectively. When the output load capacitance is “16 pF,” the frequency limitation values corresponding to the time elements “1 ns,” “2 ns,” “4 ns” and “8 ns” are “100 MHz,” “300 MHz,” “100 MHz” and “100 MHz,” respectively. Here, the frequency limitation values “100 MHz,” “100 MHz,” “100 MHz” and “100 MHz” are defined as frequency limitation values 41(a). These frequency limitation values 41(a) are the lowest because the calculation is made under the assumption that the electric current concentratedly flowing in the output part (the metal interconnection element 121 including the external connection node 107) is the one-way electric current.

FIG. 13B shows an example of a frequency limitation library table 16 in a case where the two-way electric current is defined as flowing in all the metal interconnection elements. For example, when the output load capacitance is “1 pF,” the frequency limitation values corresponding to the time elements “1 ns,” “2 ns,” “4 ns” and “8 ns” are “4000 MHz,” “2000 MHz,” “1000 MHz” and “500 MHz,” respectively. When the output load capacitance is “2 pF,” the frequency limitation values corresponding to the time elements “1 ns,” “2 ns,” “4 ns” and “8 ns” are “3000 MHz,” “2000 MHz,” “1000 MHz” and “500 MHz,” respectively. When the output load capacitance is “4 pF,” the frequency limitation values corresponding to the time elements “1 ns,” “2 ns,” “4 ns” and “8 ns” are “1500 MHz,” “1500 MHz,” “1000 MHz” and “500 MHz,” respectively. When the output load capacitance is “8 pF,” the frequency limitation values corresponding to the time elements “1 ns,” “2 ns,” “4 ns” and “8 ns” are “800 MHz,” “800 MHz,” “800 MHz”and “500 MHz,” respectively. When the output load capacitance is “16 pF,” the frequency limitation values corresponding to the time elements “1 ns,” “2 ns,” “4 ns” and “8 ns” are “400 MHz,” “400 MHz,” “400 MHz” and “400 MHz,” respectively. As a whole, the frequency limitation values shown in FIG. 13B are higher than the corresponding frequency limitation values shown in FIG. 13A, and the differences are large therebetween. The frequency limitation values “400 MHz,” “400 MHz,” “400 MHz” and “400 MHz” in FIG. 13B are defined as the frequency limitation values 41(b). These frequency limitation values 41(b) are approximately four times as large as the corresponding frequency limitation values 41(a) shown in FIG. 13A. That is because the calculation is made under the assumption that the electric current concentratedly flowing in the output part (the metal interconnection element 121 including the external connection node 107) is the two-way electric current. The frequency limitation library table 16 shown in FIG. 13B is not suitable for a practical use, because the frequency limitation values therein are higher than actually tolerable frequencies.

FIG. 13C shows an example of the frequency limitation library table 16 in a case where the one-way electric current is defined as flowing in all the vertically-provided metal interconnection elements, and the two-way electric current is defined as flowing in all the horizontally-provided metal interconnection elements, which is a scheme characteristic of the present invention. For example, when the output load capacitance is “1 pF,” the frequency limitation values corresponding to the time elements “1 ns,” “2 ns,” “4 ns” and “8 ns” are “2000 MHz,” “1100 MHz,” “600 MHz,” and “300MHz,” respectively. When the output load capacitance is “2 pF,” the frequency limitation values corresponding to the time elements “1 ns,” “2 ns,” “4 ns” and “8 ns” are “2000 MHz,” “1100 MHz,” “600 MHz” and “300 MHz,” respectively. When the output load capacitance is “4 pF,” the frequency limitation values corresponding to the time elements “1 ns,” “2 ns,” “4 ns” and “8 ns” are “1300 MHz,” “3100 MHz,” “600 MHz” and “300 MHz,” respectively. When the output load capacitance is “8 pF,” the frequency limitation values corresponding to the time elements “1 ns,” “2 ns,” “4 ns” and “8 ns” are “600 MHz,” “600 MHz,” “500 MHz” and “3300 MHz,” respectively. When the output load capacitance is “16 pF,” the frequency limitation values corresponding to the time elements “1 ns,” “2 ns,” “4 ns” and “8 ns” are “400 MHz,” “400 MHz,”“400 MHz” and “300 MHz,” respectively. Unlike the frequency limitation values in the frequency limitation library table 16 shown in FIG. 13A, those in the frequency limitation library table 16 shown in FIG. 13C are not lower than necessary. Moreover, unlike the frequency limitation values in the frequency limitation library table 16 shown in FIG. 13B, those in the frequency limitation library table 16 shown in FIG. 13C are not higher than necessary. In short, the frequency limitation values included in the frequency limitation library table 16 shown in FIG. 13C are more precise. The frequency limitation values “400 MHz,” “400 MHz,” “400 MHz” and “300 MHz” in FIG. 13C are defined as frequency limitation values 41(c). Meanwhile, of the frequency limitation values 41(c), the frequency limitation value “300 MHz” is defined as a frequency limitation value 42(c). In this case, the frequency limitation values 41(c) are lower than “400 MHz,” which is a frequency limitation value 42(b) corresponding to the time element “8 ns” and the output load capacitance “16 pF,” out of the frequency limitation values 41(b). The reason why the frequency limitation value 42(c) is lower than the frequency limitation value 42(b) is that a resistance element which is the worst in terms of the amount of electric charge out of all the resistance elements in the cell is changed. The penetration electric current flowing in the first inverter 104 becomes larger than the electric current flowing in the metal interconnection element as the output part (the metal interconnection element 121 including the external connection node 107) for which the calculation is made under the assumption that the two-way electric current flows therein, when the input waveform skew becomes larger. As a result, the metal interconnection element which is the worst in terms of the amount of electric charge is changed to one of the vertically-provided metal interconnection elements (for which the calculation is made under the assumption that the one-way electric current flows therein) included in the first inverter 104.

### Second Exemplary Embodiment

In a second exemplary embodiment, descriptions for the points that are common to the first exemplary embodiment are omitted. The second exemplary embodiment generates a more precise EM reliability verification library by preparing a cell layout library concerning the location of an output connected to the outside of the cell.

### [Operation]

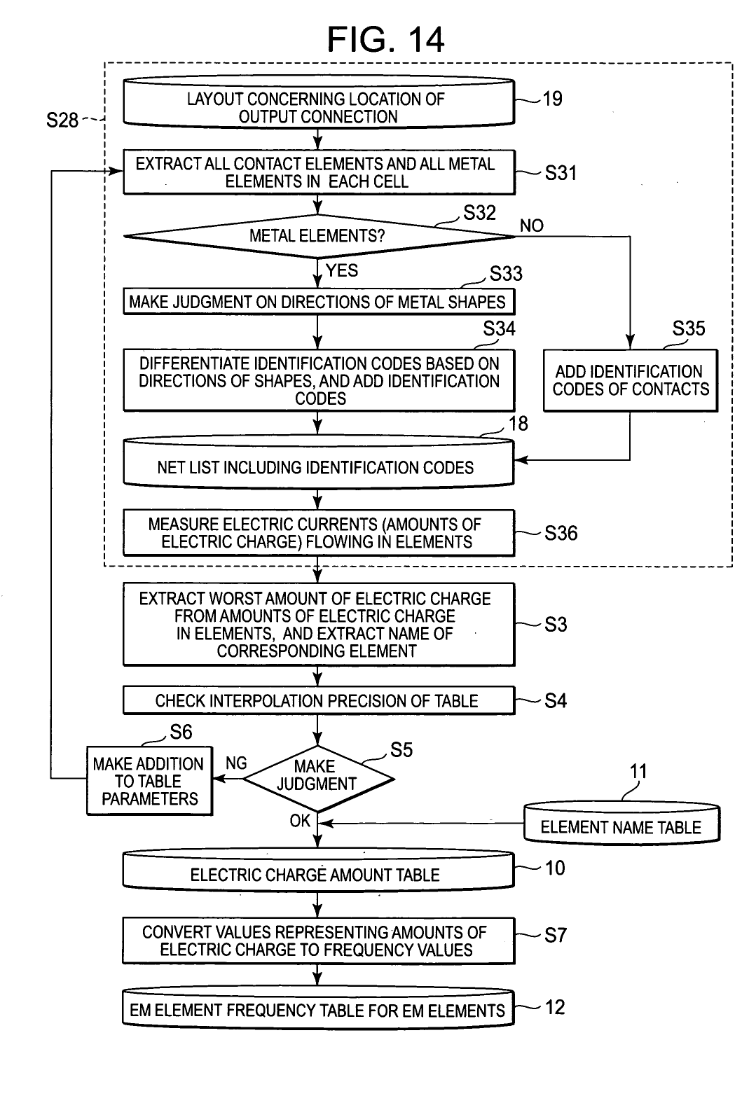

FIG. 14 is a flowchart showing a process of generating an EM reliability verification library (step S8) included in a method of generating a reliability verification library according to the second exemplary embodiment of the present invention.

In the step S8, the CPU 47 executes a step S28 instead of the step S27, which has been described above. The step S28 includes a resistance extracting step S31, a determination step S32, a metal shape-direction judging step S33, a metal identification code adding step S34, an identification code adding step S35 and an electric charge amount measuring step S36.

First of all, a cell layout library 19 is generated as the cell layout library 17, which has been described above. When a cell is designed, consideration is given to an external connection node 107 connected to the outside of the cell and its location. For this reason, data on the cell and data on the external connection node 107 are stored in the cell layout library 19.

In the resistance extracting step S31, by referring to the cell layout library 19, the CPU 47 extracts data on multiple resistance elements as all of the resistance elements from the data on the cell. In addition, by referring to the cell layout library 19, the CPU 47 identifies the external connection node 107 and its location from the data on the external connection node 107. The external connection node 107 is provided to one of the metal interconnection elements of the second metal interconnection element group. The external connection node 107 represents a place on which the electric current concentrates most in the cell.

In the determination step S32, the CPU 47 determines whether or not each of the multiple resistance elements is a metal interconnection element.

Of the multiple resistance elements, resistance elements of the first and second resistance element groups are metal interconnection elements. In other words, the first and second resistance element groups represent the resistances of the first and second metal interconnection element groups (in a case of Yes in the step S32). In this case, the CPU 47 proceeds to the metal shape-direction judging step S33, and judges which direction each of the first and second metal interconnection element groups is provided in.

In the metal identification code adding step S34, the CPU 47 generates a net list 18 in which data on the first metal interconnection element group, a resistance value of the first metal interconnection element group and an identifier (hereinafter referred to as an “identification code”) representing the one-way electric current are associated together. In addition, the CPU 47 associates together data on the second metal interconnection element group, a resistance value of the second metal interconnection element group and an identification code representing the two-way electric current, in the net list 18. Furthermore, the CPU 47 associates data on the one metal interconnection element with a code representing the external connection node 107, in the net list 18.

Of the multiple resistance elements, resistance elements of neither the first nor second resistance element group are not metal interconnection elements. In other words, resistance elements of a third resistance element group represent resistances of the multiple contact elements (in a case of No in the step S32). In this case, the CPU 47 proceeds to the identification code adding step S35, and associates sets of data on the multiple contact elements with resistance values of the multiple contact elements, respectively, in the net list 18.

In the electric charge amount measuring step S36, by referring to the net list 18, the CPU 47 makes a simulation on the basis of the predetermined first formula, the resistance values of the first and second metal interconnection element groups, the identification codes representing the one-way and two-way electric currents corresponding to the first and second metal interconnection element groups, the resistance values of the multiple contact elements, and the code representing the external connection node 107. Thus, the CPU 47 calculates an electric current consumption which is consumed by the cell. At this time, as multiple amounts of electric charge, electric currents (amounts of electric charge) flowing in the multiple resistance elements (the first and second metal interconnection element groups as well as the multiple contact elements) inside the cell are sampled by the CPU 47.

### [Demonstration]

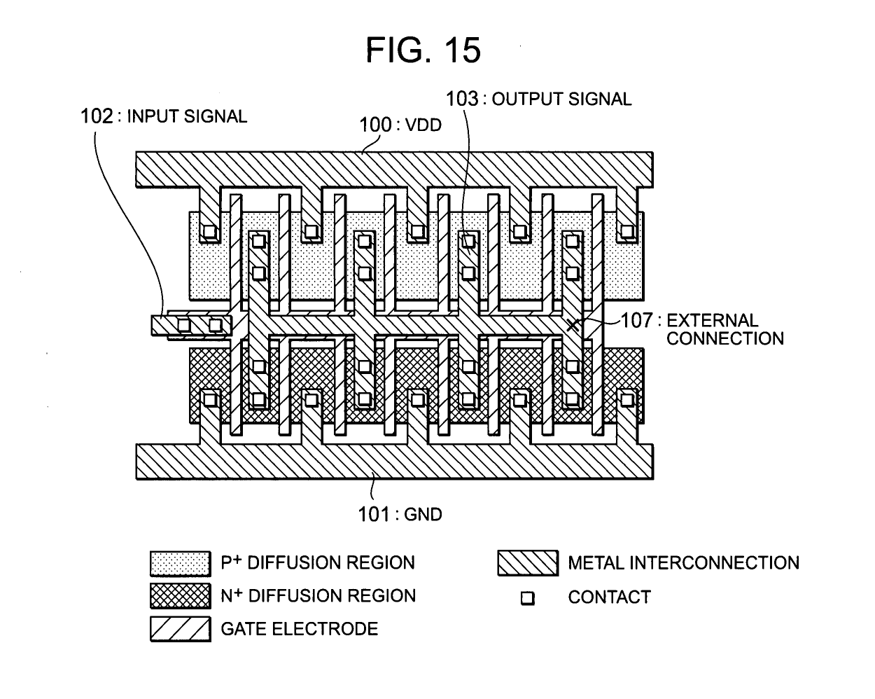

Descriptions will be provided by using a general inverter cell. FIG. 15 shows a diagram of a layout of the inverter cell.

The inverter cell includes P channel transistors and N channel transistors which are respectively connected together in series. A first voltage supply VDD100 is connected to the sources of the P channel transistors. A second voltage supply GND101 is connected to the sources of the N channel transistors. The gates of the P channel transistors and the gates of the N channel transistors constitute an input of the inverter cell. The drains of the P channel transistors and the drains of the N channel transistors constitute an output of the inverter cell. An input signal 102 is supplied to the input of the inverter cell. The inverter cell inverts the signal level of the input signal 102, and outputs the resultant signal as an output signal 103.

Multiple metal interconnection elements are provided on the P channel transistors (P+ diffusion region) and the N channel transistors (N+ diffusion region).

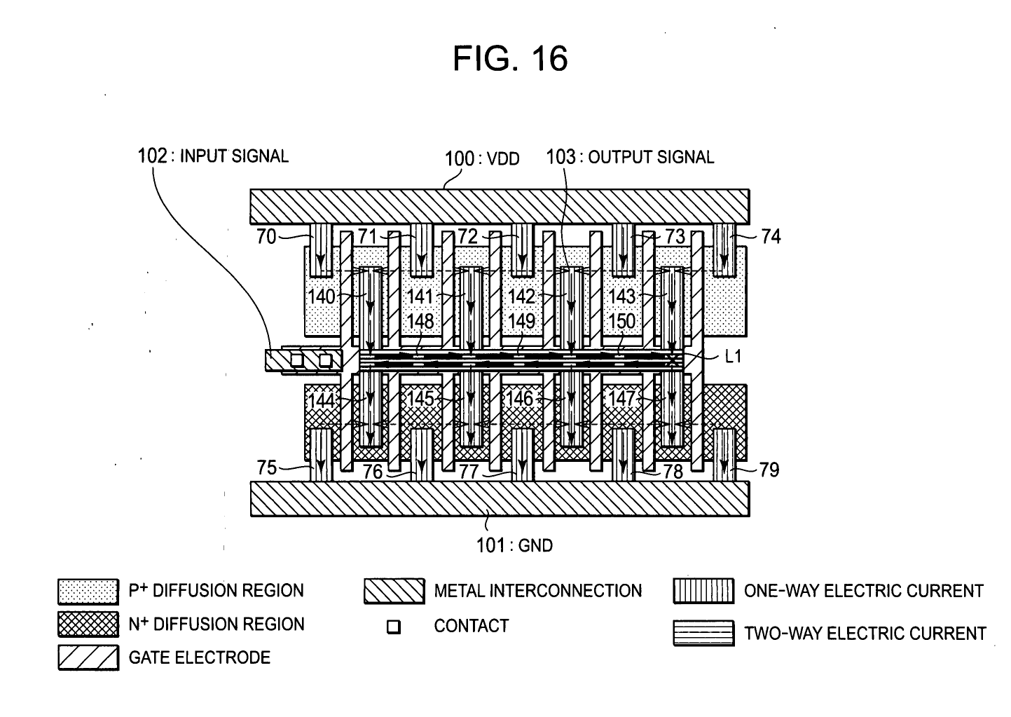

FIG. 16 shows how an electric current flows in each of the metal interconnection elements in the cell on the basis of the electric current paths shown in the layout diagram (the location of the external connection node 107 is defined as a connection location L1) of FIG. 15. Here, it is assumed that the multiple metal interconnection elements include multiple metal interconnection elements 70 to 79 and 140 to 150. The metal interconnection elements 70 to 74 are connected to the first voltage supply VDD100. The metal interconnection elements 75 to 79 are connected to the second voltage supply GND101. The two-way electric current flows only in the horizontally-provided metal interconnection elements 148 to 150 out of the multiple metal interconnection elements 70 to 79 and 140 to 150. The one-way electric current flows in the other metal interconnection elements 70 to 79 and 140 to 147. The metal interconnection elements 148 to 150 are connected together in series in this sequence.

As shown in FIG. 16, for example, the metal interconnection element 150 is used to output the output signal. The external connection node 107 (connection location L1) is provided in the metal interconnection element 150.

In this case, the electric current which flows from the first voltage supply VDD100 into each transistor flows toward the connection location L1. As a result, the greatest amount of electric current flows in the metal interconnection element 150. The relationship among the electric currents flowing in the respective multiple metal interconnection elements is almost as follows in terms of amount.

$$With regard to the supply paths from the first voltage supply VDD 100 , \\ the metal interconnection element 140 = the metal interconnection element 141 = the metal interconnection element 142 = the metal interconnection element 143 , \\ the metal interconnection element 148 = the metal interconnection element 140 , \\ the metal interconnection element 149 = the metal interconnection element 140 + the metal interconnection element 141 , \\ and the metal interconnection element 150 = the metal interconnection element 140 + the metal interconnection element 141 + the metal interconnection element 142.$$

$$With regard to the paths through which the electric charges accumulated in the external capacitances are attracted into the second voltage suppy GND 101 , \\ the metal interconnection element 144 = the metal interconnection element 145 = the metal interconnection element 146 = the metal interconnection element 147 , \\ the metal interconnection element 148 = the metal interconnection element 144 , \\ the metal interconnection element 149 = the metal interconnection element 144 + the metal interconnection element 145 , \\ and the metal interconnection element 150 = the metal interconnection element 144 + the metal interconnection element 145 + the metal interconnection element 146.$$

The one-way electric current flows in each of the metal interconnection elements 140 to 143, the metal interconnection elements 144 to 147 and the metal interconnection elements 70 to 79. The two-way electric current flows in the metal interconnection elements 148 to 150. The electric currents from the respective 6 transistors are collected together in the metal interconnection element 150, and thus the greatest amount of electric current flows in the metal interconnection element 150. The calculation is made under the assumption that the two-way electric current flows in the metal interconnection element 150. This assumption is based on the fact that the two-way electric current actually flows in the metal interconnection element 150, and also that the metal interconnection element 150 is judged as being provided in the horizontal direction by the method according to the present invention in which the type of an electric current is defined on the basis of the direction of the layout shape.

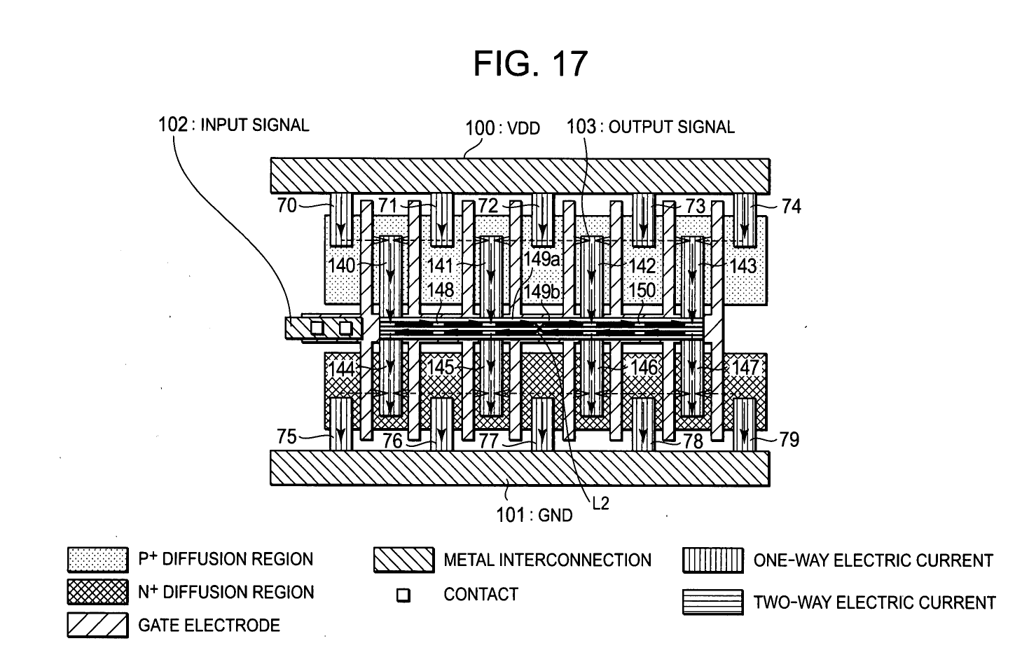

FIG. 17 shows how an electric current flows in each metal interconnection element in the cell on the basis of the electric current paths shown in the layout diagram of FIG. 15 with the location of the external connection node 107 being assumed as a connection location L2. It is assumed herein that, as shown in FIG. 17, for example, the metal interconnection element 149 is used to output the output signal, and that the external connection node 107 (connection location L2) is provided in a center portion of the metal interconnection element 149. The metal interconnection element 149 is divided into a metal interconnection element 149:a and a metal interconnection element 149:b by the connection location L2.

In this case, the electric current which flows from the first voltage supply VDD100 into each transistor flows toward the connection location L2. As a result, the greatest amount of electric current flows in the metal interconnection element 149:a and the metal interconnection element 149:b. However, because the connection location L2 is situated in the center of the metal interconnection element 149, the electric currents are decentralized. Consequently, only electric currents from four transistors are collected together. For this reason, the EM reliability verification library concerning the worst case can be generated by use of the connection location L1 shown in FIG. 16.

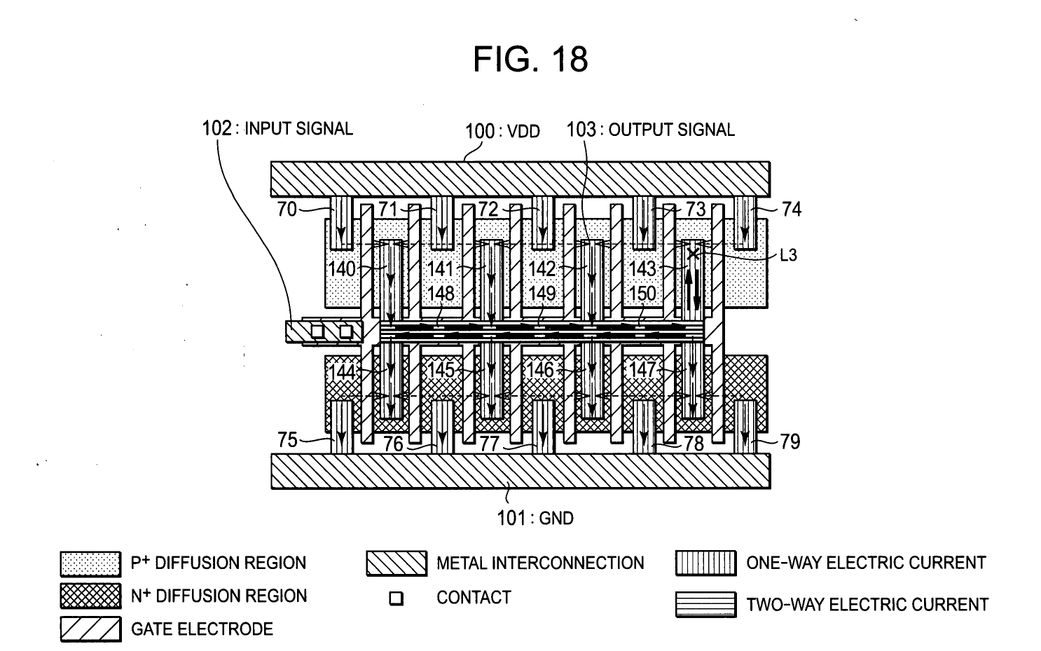

FIG. 18 shows how an electric current flows in each metal interconnection element in the cell on the basis of the electric current paths shown in the layout diagram of FIG. 15 with the location of the external connection node 107 being assumed as a connection location L3. It is assumed herein that, as shown in FIG. 18, for example, the metal interconnection element 143 is used to output the output signal, and that the external connection node 107 (connection location L3) is provided in the metal interconnection element 143. The metal interconnection element 143 is connected to the metal interconnection element 150, and is provided on the P+ diffusion region.

In this case, the electric current which flows from the first voltage supply VDD100 into each transistor flows toward the connection location L3. As a result, the greatest amount of electric current flows in the metal interconnection element 143. The electric currents from the respective 8 transistors are collected together in the metal interconnection element 143. Thus, among the connection location L1 to L3, the connection location L3 is where the electric current is concentrated most. The two-way electric current actually flows in the metal interconnection element 143. However, because the metal interconnection element 143 is judged as being provided in the vertical direction by the method according to the present invention in which the type of an electric current flowing in a metal interconnection element is defined on the basis of the direction of the layout shape, the calculation is made under the assumption that the one-way electric current flows in the metal interconnection element 143. As a result, frequency limitation values lower than necessary are compiled into the EM reliability verification library. Because of this, the EM reliability verification library with a higher precision can be generated by using the scheme of the second exemplary embodiment rather than the scheme of the first exemplary embodiment.

The method of generating a reliability verification library according to the second exemplary embodiment of the present invention is capable of generating an EM reliability verification library with a higher precision than the first exemplary embodiment, by providing the external connection node 107 in a horizontally-provided metal interconnection element and setting the same in a place on which the electric current concentrates most.

### Third Exemplary Embodiment

In a third exemplary embodiment, descriptions for the points that are common to the first and second exemplary embodiments are omitted. The third exemplary embodiment generates a more precise EM reliability verification library by additionally identifying the widths of the respective metal interconnection elements. Here, the widths of the multiple metal interconnection elements are equal to one another as in the case of the first exemplary embodiment.

### [Operation]

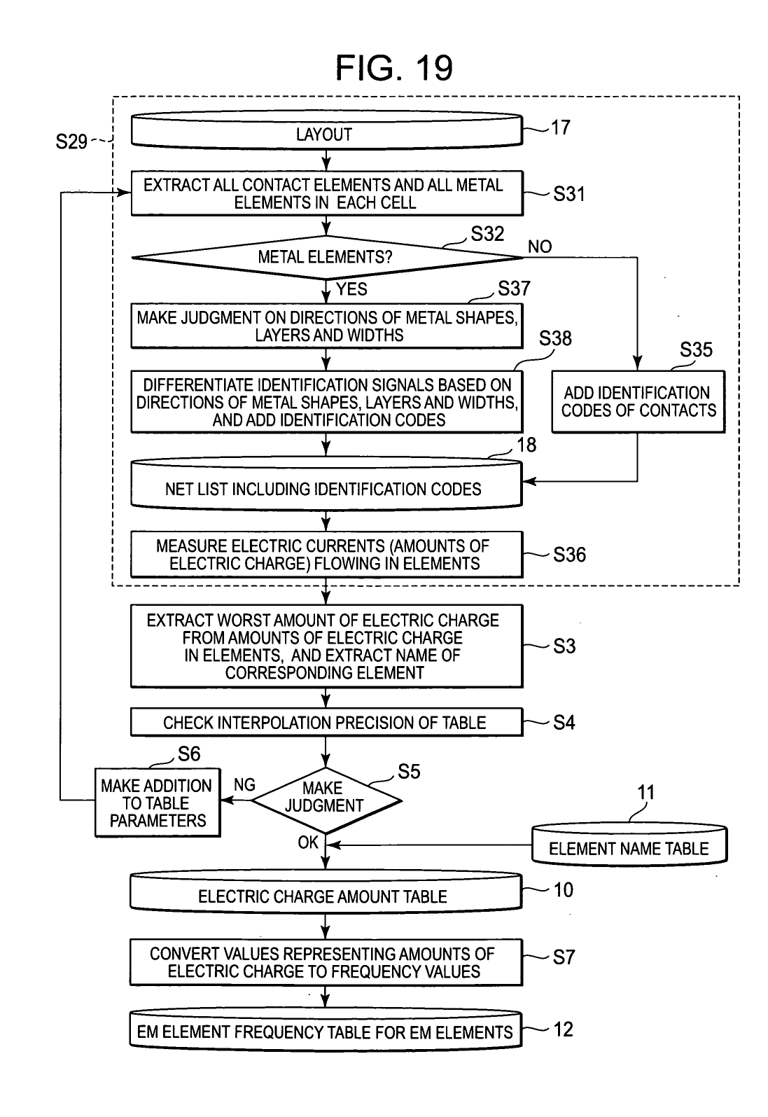

FIG. 19 is a flowchart showing a process of generating an EM reliability verification library (step S8) included in a method of generating a reliability verification library according to the third exemplary embodiment of the present invention.

In the step S8, the CPU 47 executes a step S29 instead of the step S27, which has been described above. The step S29 includes a resistance extracting step S31, a determination step S32, a metal shape-direction/layer/width judging step S37, a metal detailed identification code adding step S38, an identification code adding step S35 and an electric charge amount measuring step S36. In other words, the CPU 47 executes the metal shape-direction/layer/width judging step S37 instead of the metal shape-direction judging step S33, and also executes the metal detailed identification code adding step S38 instead of the metal identification code adding step S34.

In the resistance extracting step S31, by referring to a cell layout library 17, the CPU 47 extracts data on multiple resistance elements as all of the resistance elements from data on a cell.

In the determination step S32, the CPU 47 determines whether or not each of the multiple resistance elements is a metal interconnection element.

Of the multiple resistance elements, resistance elements of the first and second resistance element groups are metal interconnection elements. In other words, the first and second resistance element groups represent the resistances of the first and second metal interconnection element groups (in a case of Yes in the step S32). In this case, the CPU 47 proceeds to the metal shape-direction/layer/width judging step S37, and judges which direction each of the first and second metal interconnection element groups is provided in. In this respect, the first and second interconnection element groups are provided in the vertical and horizontal directions, respectively. Furthermore, the CPU 47 makes a judgment on the width and layer of each of the multiple metal interconnection elements.

In the metal detailed identification code adding step S38, the CPU 47 generates a net list 18 in which data on the first metal interconnection element group, a resistance value of the first metal interconnection element group and an identifier code representing the one-way electric current are associated together. In addition, the CPU 47 associates together data on the second metal interconnection element group, a resistance value of the second metal interconnection element group and an identification code representing the two-way electric current, in the net list 18. Furthermore, the CPU 47 associates sets of data on the multiple metal interconnection elements with identification codes representing the widths and layers of the multiple metal interconnection elements, respectively, in the net list.

Of the multiple resistance elements, resistance elements of neither the first nor second resistance element group are not metal interconnection elements. In other words, resistance elements of a third resistance element group represent resistances of multiple contact elements (in a case of No in the step S32). In this case, the CPU 47 proceeds to the identification code adding step S35, and associates sets of data on the multiple contact elements with resistance values of the multiple contact elements, respectively, in the net list 18.

In the electric charge amount measuring step S36, by referring to the net list 18, the CPU 47 makes a simulation on the basis of the predetermined first formula, the resistance values of the first and second metal interconnection element groups, the identification codes representing the one-way and two-way electric currents corresponding to the first and second metal interconnection element groups, the identification codes representing the widths and widths of the multiple metal interconnection elements, as well as the resistance values of the multiple contact elements. Thus, the CPU 47 calculates an electric current consumption which is consumed by the cell. At this time, as multiple amounts of electric charge, electric currents (amounts of electric charge) flowing in the multiple resistance elements (the first and second metal interconnection element groups as well as the multiple contact elements) inside the cell are sampled by the CPU 47.

### [Demonstration]

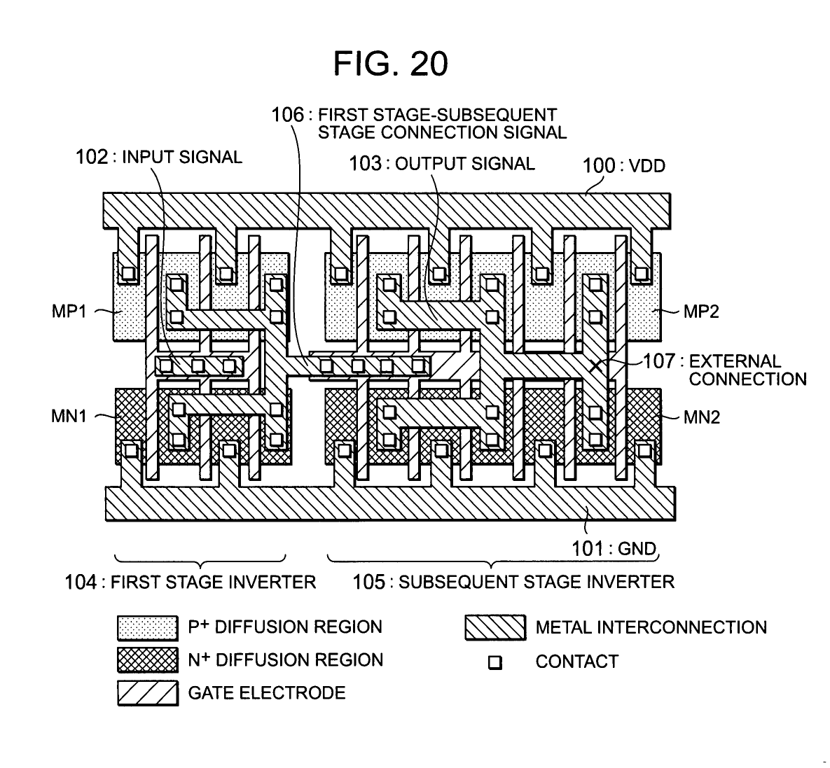

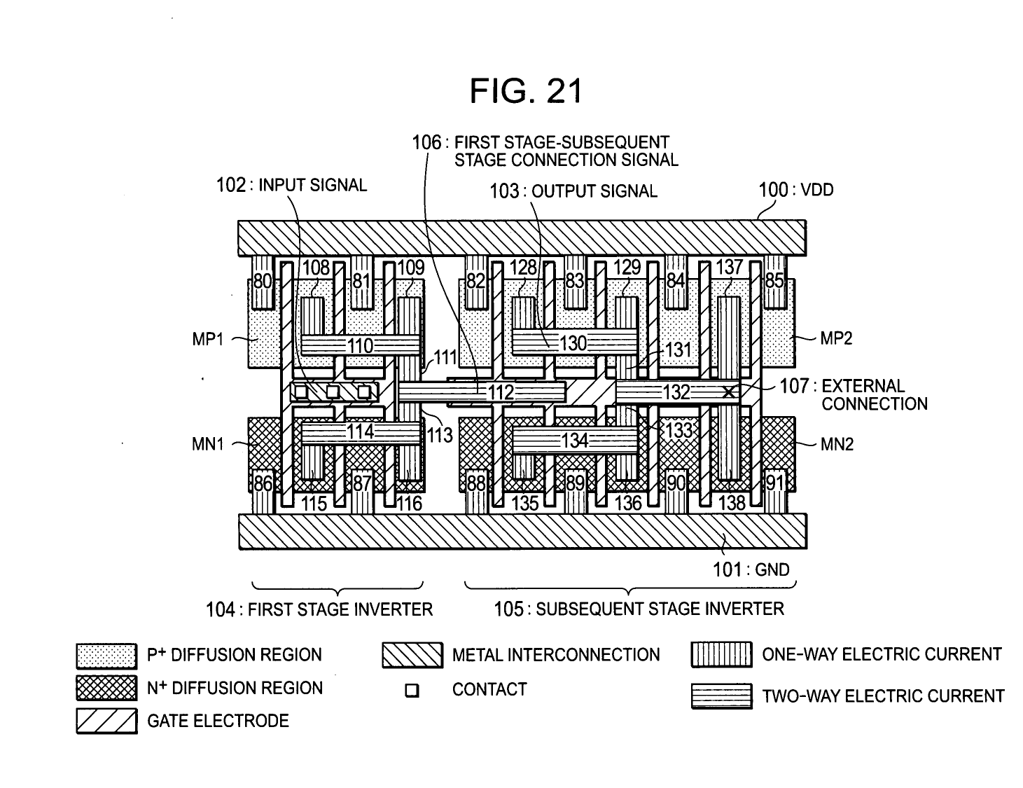

FIG. 20 shows a diagram of a layout of a buffer cell. FIG. 21 is a diagram showing a case where the one-way electric current is defined as flowing in the first metal interconnection element group provided in the vertical direction, and the two-way electric current is defined as flowing in the second metal interconnection element group provided in the horizontal direction.

Here, it is assumed that the multiple metal interconnection elements include multiple metal interconnection elements 80 to 91, 108 to 116 and 128 to 138. The metal interconnection elements 80 to 85 are connected to a first voltage supply VDD100. The metal interconnection elements 86 to 91 are connected to a second voltage supply GND101. The first metal interconnection element group includes metal interconnection elements 80 to 91, 108, 109, 111, 113, 115, 116, 128, 129, 131, 133, 135, 136, 137 and 138 out of the multiple metal interconnection elements 80 to 91, 108 to 116 and 128 to 138. The second metal interconnection element group includes metal interconnection elements 110, 112, 114, 130, 132 and 134. The metal interconnection elements 110, 112 and 114 are narrow in width. The two-way electric current flows in each of the metal interconnection elements 110, 112 and 114. The metal interconnection elements 80 to 91, 108, 109, 111, 113, 115 and 116 are narrow in width. The one-way electric current flows in each of the metal interconnection elements 80 to 91, 108, 109, 111, 113, 115 and 116. The metal interconnection elements 130, 132 and 134 are wide in width. The two-way electric current flows in each of the metal interconnection elements 130, 132 and 134. The metal interconnection elements 128, 129, 131, 133, 135, 136, 137 and 138 are wide in width. The one-way electric current flows in each of the metal interconnection elements 128, 129, 131, 133, 135, 136, 137 and 138. Identification codes respectively representing these can be classified into four types. Here, each of the widths is described by a uniform value. For instance, the narrow width is 0.1 μm, and the wide width is 0.2 μm.

The identification codes representing the widths and layers of the multiple metal interconnection elements are realized by changing the characters included in the character string 32 for representing a layer of a resistance shown in FIG. 7.

The method of generating a reliability verification library according to the third exemplary embodiment of the present invention is capable of generating an EM reliability verification library with a far higher precision than the first exemplary embodiment, by identifying the widths of the metal interconnection elements. The reason for the higher precision is as follows. In a case where, of the multiple metal interconnection elements, metal interconnection elements are wider in width than the other metal interconnection elements, the allowable electric current values of the metal interconnection elements are larger than those of the other metal interconnection elements. For this reason, an EM reliability verification library more suitable for the practical use can be generated when the frequency limitation values are calculated with consideration being given to the widths of the respective multiple metal interconnection elements than when the frequency limitation values are calculated on the basis of the tolerable electric current values with no consideration being given to the widths of the respective multiple metal interconnection elements. With regard to the layers of the metal interconnection elements, too, it is likely that the tolerable electric current values may vary depending on their layers. For this reason, an EM reliability verification library more suitable for the practical use can be generated when the frequency limitation values are calculated with consideration being given to the layers of the respective multiple metal interconnection elements than when the frequency limitation values are calculated on the basis of the tolerable electric current value of a layer whose tolerable electric current value is the smallest out of the multiple metal interconnection elements with no consideration being given to the layers of the respective multiple metal interconnection elements.

Note that the present invention can be carried out through combinations of the first to third exemplary embodiments.

### Fourth Exemplary Embodiment

In a fourth exemplary embodiment, descriptions for the points that are common to the first to third exemplary embodiments are omitted. The fourth exemplary embodiment generates an EM reliability verification library with a very much higher precision by additionally identifying the types of the contacts.

### [Operation]

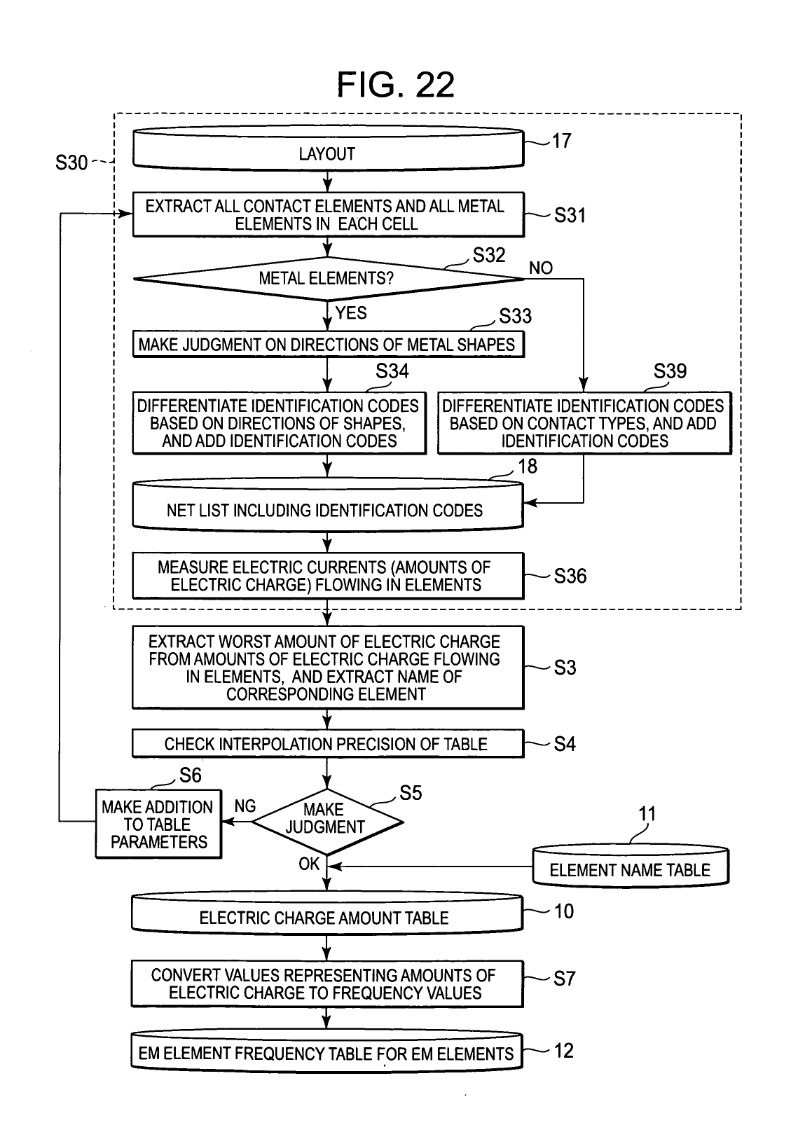

FIG. 22 is a flowchart showing a process of generating an EM reliability verification library (step S8) included in a method of generating a reliability verification library according to the fourth exemplary embodiment of the present invention.

In the step S8, the CPU 47 executes a step S30 instead of the step S27, which has been described above. The step S30 includes a resistance extracting step S31, a determination step S32, a metal shape-direction judging step S33, a metal identification code adding step S34, a detailed identification code adding step S39 and an electric charge amount measuring step S36. In other words, the CPU 47 executes the detailed identification code adding step S39 instead of the identification code adding step S35.

In the resistance extracting step S31, by referring to the cell layout library 17, the CPU 47 extracts data on multiple resistance elements as all of the resistance elements from data on a cell.

In the determination step S32, the CPU 47 judges whether or not each of the multiple resistance elements is a metal interconnection element.

Of the multiple resistance elements, resistance elements of the first and second resistance element groups are metal interconnection elements. In other words, the first and second resistance element groups represent the resistances of the first and second metal interconnection element groups (in a case of Yes in the step S32). In this case, the CPU 47 proceeds to the metal shape-direction judging step S33, and judges which direction each of the first and second metal interconnection element groups is provided in. In this respect, the first and second interconnection element groups are provided in the vertical and horizontal directions, respectively.

In the metal identification code adding step S34, the CPU 47 generates a net list 18 in which data on the first metal interconnection element group, a resistance value of the first metal interconnection element group and an identification code representing the one-way electric current are associated together. In addition, the CPU 47 associates together data on the second metal interconnection element group, a resistance value of the second metal interconnection element group and an identification code representing the two-way electric current, in the net list 18.

Of the multiple resistance elements, resistance elements of neither the first nor second resistance element group are not metal interconnection elements. In other words, resistance elements of a third resistance element group represent resistances of multiple contact elements connected to the multiple metal interconnection elements (in a case of No in the step S32). In this case, the CPU 47 proceeds to the detailed identification code adding step S39, and further associates together data on a first contact element group, among the multiple contact elements, consisting of contact elements connected to diffusion layers, a resistance value of the first contact element group and the identification code representing the one-way electric current, in the net list 18. In addition, the CPU 47 associates together data on a second contact element group consisting of contact elements, among the multiple contact elements, connected to gates, a resistance value of the second contact element group and the identification code representing the two-way electric current, in the net list 18.

In the electric charge amount measuring step S36, by referring to the net list 18, the CPU 47 makes a simulation on the basis of the predetermined first formula, the resistance values of the first and second metal interconnection element groups, the identification codes representing the one-way and two-way electric currents corresponding to the first and second metal interconnection element groups, the resistance values of the first and second contact element groups, as well as the identification codes representing the one-way and two-way electric currents corresponding to the first and second contact element groups. Thus, the CPU 47 calculates an electric current consumption which is consumed by the cell. At this time, as multiple amounts of electric charge, electric currents (amounts of electric charge) flowing in the multiple resistance elements (the first and second metal interconnection element groups as well as the first and second contact element groups) inside the cell are sampled by the CPU 47.

### [Demonstration]

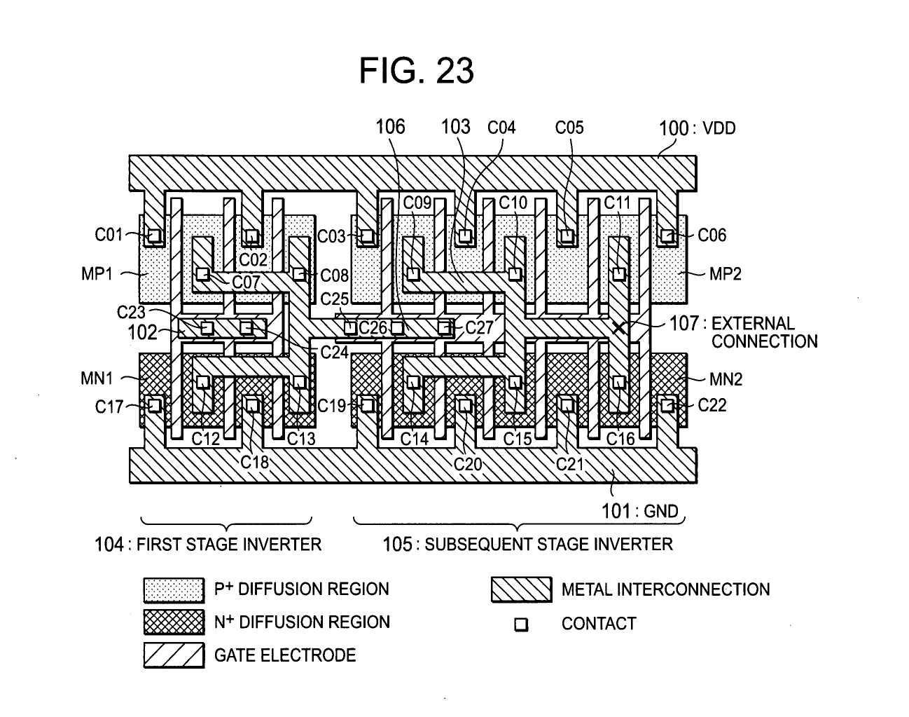

FIG. 23 shows a diagram of a layout of a buffer cell. Here, it is assumed that contact elements connected to the first metal interconnection element group are contact elements C01 to C22, and that contact elements connected to the second metal interconnection element group are contact elements C23 to C27. The multiple contact elements in the cell are of two types: contact elements each connecting a diffusion region and a metal interconnection element together; and contact elements each connecting a gate and a metal interconnection element together. The contact elements C01 to C22 are the contact elements each connecting a diffusion region and a metal interconnection element together. The contact elements C23 to C27 are the contact elements each connecting a gate and a metal interconnection element together.

Descriptions will be provided for the contact elements C01 to C22 by taking the contact elements C01, C07, C12 and C17 as examples. In this case, the contact element C01 plays a role in causing an electric current flowing from the first voltage supply VDD100 to flow into a diffusion region MP1. The contact element C07 plays a role in causing an electric current flowing via a gate electrode to flow as the first stage-subsequent stage connection signal 106. The contact element C12 plays a role in causing the electric current flowing as the first stage-subsequent stage connection signal 106 to flow to an N+ diffusion region MN1. The contact element C17 plays a role in causing an electric current flowing via a gate electrode to flow into the second voltage supply GND101. In this way, the one-way electric current flows in each of the contact elements C01 to C22.

Descriptions will be provided for the contact elements C23 to C27 by taking the contact elements C25 to C27 as examples. In this case, the contacts elements C25 to C27 play a role in causing the electric current flowing thereinto as the first stage-subsequent stage connection signal 106 from the first voltage supply VDD100 via the first stage inverter to flow to the gate electrode of the subsequent stage inverter 105, and play a role in causing electric charge accumulated in the gate electrode to flow to the second voltage supply GND101 as the first stage-subsequent stage connection signal 106. In this way, the two-way electric current flows in each of the contact elements C23 to C27.

It is assumed herein that each of the multiple contact elements represents a contact or via in the cell. In this case, identification codes representing the multiple contact elements are realized by changing the characters constituting the character string 32 for representing a layer of a resistance shown in FIG. 7.

The method of generating a reliability verification library according to the fourth exemplary embodiment is capable of generating an EM reliability verification library with a very much higher precision than the first exemplary embodiment, by additionally identifying the contact elements.

Note that the present invention can be carried out through combinations of the first to fourth exemplary embodiments.

What is claimed is:

1. A method of generating a reliability verification library, comprising:
generating a cell layout library in which data on a cell is stored, the cell including a plurality of metal interconnection elements, the plurality of metal interconnection elements including a first metal interconnection element group in which the metal interconnection elements are provided in a first direction and in which an electric current flows, as a one-way electric current, in any one of the first direction and a direction opposite to the first direction, and a second metal interconnection element group in which the metal interconnection elements are provided in a second direction and in which an electric current flows, as a two-way electric current, in both of the second direction and a direction opposite to the second direction; and
generating a net list by referring to the cell layout library, the net list associating data on the first and second metal interconnection element groups with corresponding resistance values of the first and second metal interconnection element groups, and corresponding identifiers representing the one-way and two-way electric currents.

2. The method of generating a reliability verification library according to claim 1, wherein, in the generating the net list, by referring to the cell layout library, data on the plurality of metal interconnection elements are also associated with identifiers representing widths of the plurality of metal interconnection elements, respectively, in the net list.

3. The method of generating a reliability verification library according to claim 1, wherein, in the generating the net list, by referring to the cell layout library, data on the plurality of metal interconnection elements are also associated with identifiers representing widths and layers of the plurality of metal interconnection elements, respectively, in the net list.

4. The method of generating a reliability verification library according to claim 1, wherein
the cell further includes a plurality of contact elements connected to the plurality of metal interconnection elements, and
in the generating the net list, by referring to the cell layout library, data on the plurality of contact elements are also associated with resistance values of the plurality of contact elements, respectively, in the net list.

5. The method of generating a reliability verification library according to claim 4, wherein, in the generating the net list, by referring to the cell layout library, data on first and second contact element groups out of the plurality of contact elements are also associated with corresponding resistance values of the first and second contact element groups, and the corresponding identifiers representing the one-way and two-way electric currents, respectively, in the net list, the first contact element group being connected to diffusion regions, and the second contact element group being connected to gates.

6. The method of generating a reliability verification library according to claim 5, wherein each of the plurality of contact elements represents any one of a contact and a via.

7. The method of generating a reliability verification library according to claim 1, wherein
a metal interconnection element of the second metal interconnection element group includes an external connection node connected to an outside of the cell, the external connection node representing a place on which the electric current concentrates most, and
in the generating the net list, by referring to the cell layout library, data on the one metal interconnection element is also associated with a code representing the external connection node, in the net list.

8. The method of generating a reliability verification library according to claim 1, further comprising:
calculating an electric current which is consumed by the cell, on a basis of a predetermined first formula by referring to the net list;
converting the electric current to a frequency limitation value on a basis of a predetermined second formula; and
generating a frequency limitation table in which the frequency limitation value is stored.

9. A computer program product for causing a computer to execute the generating the reliability verification library according to claim 1.

10. A reliability verification library generator, comprising:
a cell layout library in which data on a cell is stored,
wherein the cell includes a plurality of metal interconnection elements,
the plurality of metal interconnection elements includes a first metal interconnection element group and a second metal interconnection element group,
in the first metal interconnection element group, the metal interconnection elements are provided in a first direction, and an electric current flows, as a one-way electric current, in any one of the first direction and a direction opposite to the first direction,
in the second metal interconnection element group, the metal interconnection elements are provided in a second direction, and an electric current flows, as a two-way electric current, in both of the second direction and a direction opposite to the second direction; and
a controller, by referring to the cell layout library, that generates a net list in which data on the first and second metal interconnection element groups are associated with corresponding resistance values of the first and second metal interconnection element groups, and corresponding identifiers representing the one-way and two-way electric currents.

11. The reliability verification library generator according to claim 10, wherein, by referring to the cell layout library, the controller also associates data on the plurality of metal interconnection elements with identifiers representing widths of the plurality of metal interconnection elements, respectively, in the net list.

12. The reliability verification library generator according to claim 10, wherein, by referring to the cell layout library, the controller also associates data on the plurality of metal interconnection elements with identifiers representing widths and layers of the plurality of metal interconnection elements, respectively, in the net list.

13. The reliability verification library generator according to claim 10, wherein
the cell further includes a plurality of contact elements connected to the plurality of metal interconnection elements, and
by referring to the cell layout library, the controller also associates data on the plurality of contact elements with resistance values of the plurality of contact elements, respectively, in the net list.

14. The reliability verification library generator according to claim 13, wherein, by referring to the cell layout library, the controller also associates data on first and second contact element groups out of the plurality of contact elements with corresponding resistance values of the first and second contact element groups, and the corresponding identifiers representing the one-way and two-way electric currents, respectively, in the net list, the first contact element group being connected to diffusion regions, and the second contact element group being connected to gates.

15. The reliability verification library generator according to claim 14, wherein each of the plurality of contact elements represents any one of a contact and a via.

16. The reliability verification library generator according to claim 10, wherein
one metal interconnection element of the second metal interconnection element group includes an external connection node connected to an outside of the cell, the external connection node representing a place on which the electric current concentrates most, and
by referring to the cell layout library, the controller also associates data on the one metal interconnection element with a code representing the external connection node, in the net list.

17. The reliability verification library generator according to claim 10, wherein
the controller calculates an electric current which is consumed by the cell, on the basis of a predetermined first formula by referring to the net list,
the controller converts the electric current to a frequency limitation value on the basis of a predetermined second formula, and
the controller generates a frequency limitation table in which the frequency limitation value is stored.

18. A reliability verification library comprising the cell layout library and the net list which are used in the reliability verification library generator according to claim 10.
